(19) United States
(12) Patent Application Publication
(10) Pub. No.: US 2024/0422763 A1
(43) Pub. Date: Dec. 19, 2024

(54) MULTI-STAGE GRANT FOR MULTIPLE RADIO ACCESS TECHNOLOGY SPECTRUM SHARING

(71) Applicant: QUALCOMM Incorporated, San Diego, CA (US)

(72) Inventors: Jing LEI, San Diego, CA (US); Jing JIANG, San Diego, CA (US); Kianoush HOSSEINI, San Diego, CA (US); Kangqi LIU, San Diego, CA (US)

(21) Appl. No.: 18/335,021

(22) Filed: Jun. 14, 2023

(51) Int. Cl. H04W 72/12

(52) U.S. Cl. CPC H04W 72/12; H04W 72/0453

(57) ABSTRACT

Various aspects of the present disclosure generally relate to wireless communication. In some aspects, a network entity may receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first radio access technology (RAT). The network entity may receive, via a second frequency carrier, the second message of the multi-stage grant, wherein the second message indicates second information associated with the communication, and wherein the second frequency carrier is associated with a second RAT. The network entity may communicate, based on the second information, the communication. Numerous other aspects are described.

### FIELD OF THE DISCLOSURE

Aspects of the present disclosure generally relate to wireless communication and to techniques and apparatuses for a multi-stage grant for multiple radio access technology (RAT) spectrum sharing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a network entity via downlink communications and uplink communications. “Downlink” (or “DL”) refers to a communication link from the network entity to the UE, and “uplink” (or “UL”) refers to a communication link from the UE to the network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network entity for wireless communication. The network entity may include at least one memory and at least one communication interface. The network entity may include at least one processor coupled to the at least one memory and the at least one communication interface. The network entity may be configured to receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first radio access technology (RAT). The network entity may be configured to receive, via a second frequency carrier, the second message of the multi-stage grant, wherein the second message indicates second information associated with the communication, and wherein the second frequency carrier is associated with a second RAT. The network entity may be configured to communicate, based on the second information, the communication.

Some aspects described herein relate to a first network entity for wireless communication. The first network entity may include at least one memory and at least one communication interface. The first network entity may include at least one processor coupled to the at least one memory and the at least one communication interface. The first network entity may be configured to transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT. The first network entity may be configured to transmit, via a second frequency carrier, the second message of the multi-stage grant, wherein the second message indicates second information associated with the communication, and wherein the second frequency carrier is associated with a second RAT. The first network entity may be configured to communicate, based on at least one of the first information or the second information, the communication.

Some aspects described herein relate to a method of wireless communication performed by a network entity. The method may include receiving, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT. The method may include receiving, via a second frequency carrier, the second message of the multi-stage grant, wherein the second message indicates second information associated with the communication, and wherein the second frequency carrier is associated with a second RAT. The method may include communicating, based on the second information, the communication.

Some aspects described herein relate to a method of wireless communication performed by a first network entity. The method may include transmitting, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT. The method may include transmitting, via a second frequency carrier, the second message of the multi-stage grant, wherein the second message indicates second information associated with the communication, and wherein the second frequency carrier is associated with a second RAT. The method may include communicating, based on at least one of the first information or the second information, the communication.

Some aspects described herein relate to a non-transitory computer-readable medium having instructions for wireless communication stored thereon. The instructions, when executed by a network entity, may cause the network entity to receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT. The instructions, when executed by the network entity, may cause the network entity to receive, via a second frequency carrier, the second message of the multi-stage grant, wherein the second message indicates second information associated with the communication, and wherein the second frequency carrier is associated with a second RAT. The instructions, when executed by the network entity, may cause the network entity to communicate, based on the second information, the communication.

Some aspects described herein relate to a non-transitory computer-readable medium having instructions for wireless communication stored thereon. The instructions, when executed by a first network entity, may cause the first network entity to transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT. The instructions, when executed by the first network entity, may cause the first network entity to transmit, via a second frequency carrier, the second message of the multi-stage grant, wherein the second message indicates second information associated with the communication, and wherein the second frequency carrier is associated with a second RAT. The instructions, when executed by the first network entity, may cause the first network entity to communicate, based on at least one of the first information or the second information, the communication.

Some aspects described herein relate to an apparatus for wireless communication. The apparatus may include means for receiving, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT. The apparatus may include means for receiving, via a second frequency carrier, the second message of the multi-stage grant, wherein the second message indicates second information associated with the communication, and wherein the second frequency carrier is associated with a second RAT. The apparatus may include means for communicating, based on the second information, the communication.

Some aspects described herein relate to an apparatus for wireless communication. The apparatus may include means for transmitting, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT. The apparatus may include means for transmitting, via a second frequency carrier, the second message of the multi-stage grant, wherein the second message indicates second information associated with the communication, and wherein the second frequency carrier is associated with a second RAT. The apparatus may include means for communicating, based on at least one of the first information or the second information, the communication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram of example components of an apparatus, in accordance with the present disclosure.

FIG. 3 is a diagram illustrating an example of a wireless network, in accordance with the present disclosure.

FIG. 4 is a diagram illustrating an environment including a network entity in wireless communication with another network entity, in accordance with the present disclosure.

FIG. 5 is a diagram illustrating an example disaggregated base station architecture, in accordance with the present disclosure.

FIG. 6 is a diagram of an example associated with multi-RAT spectrum sharing (MRSS), in accordance with the present disclosure.

FIG. 7 is a diagram of an example associated with MRSS, in accordance with the present disclosure.

FIG. 8 is a diagram of an example associated with operations associated with a multi-stage grant for multi-RAT spectrum sharing, in accordance with the present disclosure.

FIG. 9 is a diagram of an example associated with a multi-stage grant for MRSS, in accordance with the present disclosure.

FIG. 10 is a diagram illustrating an example process performed, for example, by a network entity, in accordance with the present disclosure.

FIG. 11 is a diagram illustrating an example process performed, for example, by a first network entity, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

In some network deployments, cells may be deployed that operate using high frequency bands. The high-band cells may provide increased data capacity and/or increased throughput for entities operating in a wireless network (e.g., because of an increased bandwidth associated with the high frequency bands). For example, network entities associated with a high-band cell may communicate using a larger bandwidth size, such as a 7.5 gigahertz (GHz) bandwidth, among other examples. Communicating using the larger bandwidth size may result in an increased throughput for communications between the network entities.

Radio frequency (RF) constraints and propagation properties that are unique to the high frequency bands may introduce new design challenges for wireless networks. For example, the high frequency bands may be associated with a high path loss. Therefore, to compensate for the high path loss, the network entities may communicate using narrow beams (for example, beams with a narrow beam width or signals with energy concentrated over a narrow directional range). However, the narrow beams may be susceptible to beam blockage, interference, or other intervening factors that degrade performance of signals communicated via the narrow beams. Therefore, high-band cells may be associated with a smaller coverage area (e.g., a geographic area associated with a cell) as compared to cells using a lower operating frequency (e.g., which may be referred to herein as “low-band cells”). Because of the smaller coverage area of high-band cells, in some network deployments, high-band cells may be more densely distributed in the wireless network as compared to low-band cells. For example, multiple high-band network nodes (e.g., multiple RUs) may be deployed within a coverage area of a single low-band network node (e.g., within a coverage area of a low-band cell).

Additionally, high frequency operations may be associated with a decreased efficiency of a power amplifier of the network entities. For example, a power amplifier power may decrease as a function of frequency and as a function of bandwidth. Therefore, high frequency (e.g., sub-THz) operations may be associated with lower power amplifier power and lower power amplifier efficiency. This may result in a reduced effective isotropic radiated power (EIRP) that a device is capable of producing, resulting in the reduced coverage for high-band cells. As another example, high frequency (e.g., sub-THz) operations may be associated with increased power consumption. For example, high frequency (e.g., sub-THz) operations may be associated with a larger bandwidth (e.g., due to a larger subcarrier spacing) and high data rates. The larger bandwidth, coupled with less power efficient RF processing, increased sampling rates (e.g., for an analog-to-digital converter or a digital-to-analog converter), increased digital processing rates, increased bit rates, and/or increased storage or memory requirements, among other examples, may increase power consumption of wireless communication devices using the high frequency bands, such as a sub-THz band.

The poor coverage, increased power consumption, and narrow beams associated with high-band cells and/or high-band spectrums may introduce challenges for the introduction of higher frequency RATs. For example, higher frequency cells and/or spectrums may be associated with improved throughput and/or availability, but may suffer from high propagation loss, reduced reliability, and/or reduced coverage, among other examples. Lower frequency cells and/or spectrums may be associated with improved reliability and/or coverage, but may be associated with reduced throughput and/or availability (e.g., as compared to higher frequency cells and/or spectrums). Therefore, it is beneficial to have a low-band and/or mid-band spectrum available for higher frequency RATs (e.g., for the improved availability, improved reliability, and/or improved coverage associated with the low-band and/or mid-band spectrum).

For example, network entities may communicate via a first RAT and a second RAT using one or more shared frequency domain resources (e.g., one or more shared spectrums, shared frequency bands, shared carriers, and/or shared frequency ranges). In some examples, the second RAT may be a RAT subsequent to the first RAT (e.g., the first RAT may be a “legacy” RAT and the second RAT may be a “new” RAT). In some examples, a frequency range allocated for the second RAT may include at least a portion of a frequency range allocated for the first RAT and one or more additional frequency domain resources outside of the frequency range allocated for the first RAT. The one or more additional frequency domain resources outside of the frequency range allocated for the first RAT may be associated with a higher frequency than the frequency range allocated for the first RAT. For example, the first RAT may be a 5G RAT or an NR RAT and the second RAT may be a 6G RAT. As another example, the first RAT may be a 4G RAT and the second RAT may be the 6G RAT. As another example, the first RAT may be the 6G RAT and the second RAT may be a RAT subsequent to 6G (e.g., a 7G RAT).

One or more frequency ranges and/or spectrums may be allocated for the first RAT and/or the second RAT (e.g., by a network operator associated with the wireless network). For example, a shared spectrum may be allocated for both the first RAT and the second RAT. The shared spectrum may also be referred to as a shared band, a multi-RAT shared spectrum, and/or a multi-RAT shared band, among other examples. In some examples, the shared spectrum may be included in a low-band and/or mid-band frequency range. For example, the shared spectrum may be included in FR1, FR2, and/or a millimeter wave band, among other examples. The shared spectrum may include one or more carrier frequencies (e.g., operating frequencies or frequency bands) that are available for both the first RAT and the second RAT. A network entity using the shared spectrum may communicate based on, or otherwise associated with, a scheduling grant received by the network entity (e.g., without performing a channel access procedure, such as a listen-before-talk procedure, to access the shared spectrum or shared frequency band). This increases flexibility for network entity scheduling, improves network resource utilization, and/or improves access to the wireless network by enabling the shared spectrum to be used for both the first RAT and the second RAT without a network entity performing a channel access procedure to communicate using the shared spectrum.

In some cases, a network entity (e.g., that is configured to operate using a high frequency RAT, such as the second RAT described above) may receive control information (e.g., scheduling information and/or scheduling grants, such as downlink control information (DCI)) via a shared spectrum (e.g., to improve the coverage and/or reliability of the control information). For example, using a shared spectrum associated with a low-band or mid-band spectrum may improve the coverage and/or reliability of control information transmissions associated with the high frequency RAT (e.g., as compared to transmissions of the control information using a higher frequency spectrum). However, network resources and/or bandwidth within the shared spectrum may be limited. For example, because the shared spectrum may be used for other RATs and/or other types of signaling (such as SSB transmissions, uplink control channel feedback transmissions, and/or paging transmissions), an availability of resources in the shared spectrum may be limited. Additionally, a size of the control signaling (e.g., a size of DCI) for the high frequency RAT may be large. For example, DCI for the high frequency RAT may indicate additional information (e.g., associated with features supported by the high frequency RAT that may not be supported by other RATs) resulting in a larger size (e.g., a larger payload size) of the DCI. As a result, control information that is transmitted via a shared spectrum may experience increased latency due to the limited availability of network resources in the shared spectrum. Alternatively, control information that is transmitted via a higher frequency spectrum may be associated with reduced coverage and/or reliability.

Various aspects relate generally to wireless communication and more particularly to forwarding-capable network entity reconfiguration rate control. Some aspects more specifically relate to a multi-stage grant for multi-RAT spectrum sharing. In some aspects, the multi-stage grant may include at least a first message and a second message. The first message may be communicated via a frequency that is included in a multi-RAT shared spectrum (e.g., a shared spectrum associated with a first RAT and a second RAT). The second message may be communicated via a frequency that is associated with or allocated for the second RAT (e.g., a new RAT or a higher frequency RAT). The multi-stage grant may schedule a communication that is associated with the second RAT.

In some aspects, the first message may include or otherwise indicate first information to facilitate a detection and/or decoding of the second message. For example, the first message may indicate a radio resource allocation, a priority level, a size, and/or a code rate, among other examples, to be used for the second message. The second message may include or otherwise indicate second information to facilitate a detection and/or decoding of the communication scheduled by the multi-stage grant. For example, the second message may include scheduling information or DCI associated with scheduling the communication, such as a radio resource allocation, a bandwidth part (BWP) indicator, coverage enhancement information, precoding information, antenna port information, power control information, and/or feedback information, among other examples. The communication may be a downlink communication or an uplink communication. The communication may include data information or control information. In some aspects, the communication may be, or may include, a reference signal.

A network entity may detect, decode, and/or otherwise receive the first message via a blind decoding operation. For example, the first message may be communicated via a configured search space. The network entity may detect, decode, and/or otherwise receive the second message using information (e.g., the first information) obtained via the first message.

Particular aspects of the subject matter described in this disclosure can be implemented to realize one or more of the following potential advantages. In some aspects, by scheduling the communication via the multi-stage grant, a reliability and/or coverage of the multi-stage grant may be improved (e.g., by transmitting the first message via the multi-RAT shared spectrum) while also improving a throughput of the multi-stage grant (e.g., by transmitting the second message via a frequency allocated for the second RAT that may be associated with a higher throughput and/or improved availability of network resources). For example, by transmitting the first message via the multi-RAT shared spectrum, a likelihood that a network entity is able to detect, decode, and/or otherwise receive the first message is improved (e.g., because the multi-RAT shared spectrum may be associated with a frequency range that has improved coverage and/or reliability). Moreover, by including the information for scheduling the communication in the second message, a size of the first message may be reduced, thereby conserving network resources associated with the multi-RAT shared spectrum (e.g., which may be limited as described elsewhere herein). Further, this improves network resource utilization by including the information for scheduling the communication in the second message that is transmitted via the frequency allocated for the second RAT which may be associated with a higher throughput and/or improved availability of network resources.

Additionally, the multi-stage grant may reduce the complexity and/or conserve power resources associated with DCI monitoring for communications associated with the second RAT because the network entity may be enabled to obtain information for monitoring, detecting, and/or decoding the second message from the first message. In other words, the network entity may perform blind decoding to decode or otherwise receive the first message, but may not need to perform blind decoding to decode or otherwise receive the second message (e.g., via the frequency allocated for the second RAT). Because the frequency associated with the second RAT may be associated with reduced coverage and/or reliability, eliminating the need to perform blind decoding when receiving the second message reduces the complexity and/or conserves power resources associated with receiving scheduling information (e.g., DCI) for scheduling communications associated with the second RAT.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, RF chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems are presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

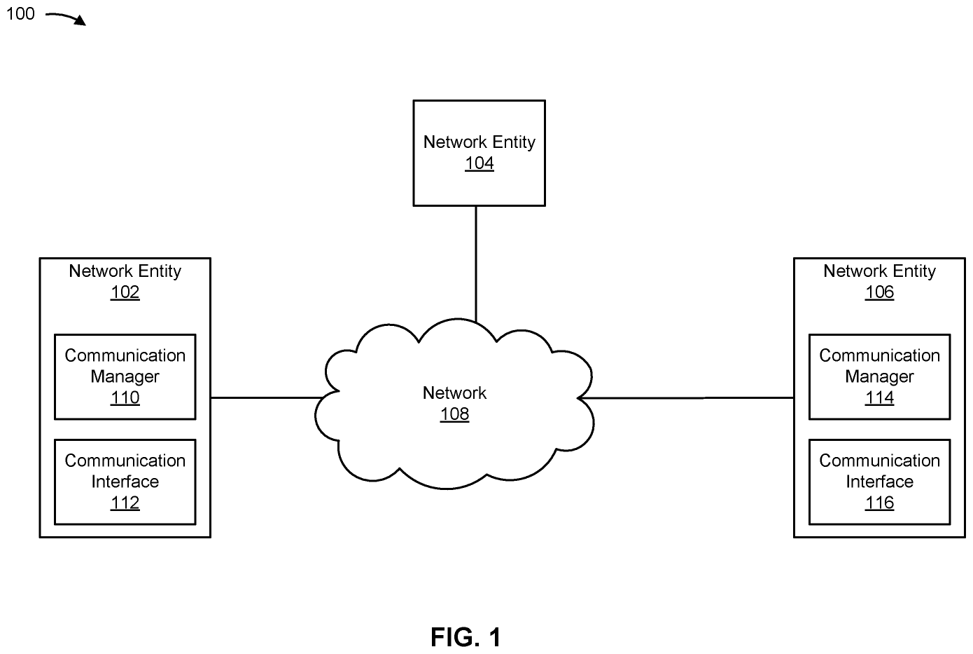

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

The network 108 may include, for example, a cellular network (e.g., a Long-Term Evolution (LTE) network, a code division multiple access (CDMA) network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

In general, any number of networks 108 may be deployed in a given geographic area. Each network 108 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, Open-RAT, NR or 5G RAT networks may be deployed.

In some aspects, the environment 100 may include one or more non-terrestrial network (NTN) deployments in which a non-terrestrial wireless communication device may include a non-terrestrial network entity (e.g., the network entity 102, 104, and 106). The non-terrestrial network entity may include a network entity such as, for example, a UE (which may be referred to herein, interchangeably, as a “non-terrestrial UE”), a base station (referred to herein, interchangeably, as a “non-terrestrial BS” and “non-terrestrial base station”), and/or a relay station (referred to herein, interchangeably, as a “non-terrestrial relay station”), among other examples. As used herein, “NTN” may refer to a network for which access is facilitated by a non-terrestrial network entity such as a non-terrestrial UE, a non-terrestrial base station, and/or a non-terrestrial relay station, among other examples.

One or more of the network entities 102, 104, and 106 may be, include, or be included in, any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. Satellites may communicate directly and/or indirectly with other entities in the environment using satellite communication. The other entities may include UEs (e.g., terrestrial UEs and/or non-terrestrial UEs), other satellites in the one or more NTN deployments, other types of base stations (e.g., stationary and/or ground-based base stations), relay stations, and/or one or more components and/or devices included in a core network, among other examples.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a communication manager 110 and one or more communication interfaces 112. The communication manager 110 may be configured to perform one or more communication tasks as described herein. In some aspects, the communication manager 110 may direct the communication interface 112 to perform one or more communication tasks as described herein. Similarly, the network entity 106 may include a communication manager 114 and one or more communication interfaces 116. The communication manager 114 may be configured to perform one or more communication tasks as described herein. In some aspects, the communication manager 114 may direct the communication interface 116 to perform one or more communication tasks as described herein. Although depicted, for clarity of description, with reference only to the network entities 102 and 104, any one or more of the network entities 102, 104, and 106 also may include a communication manager and a communication interface.

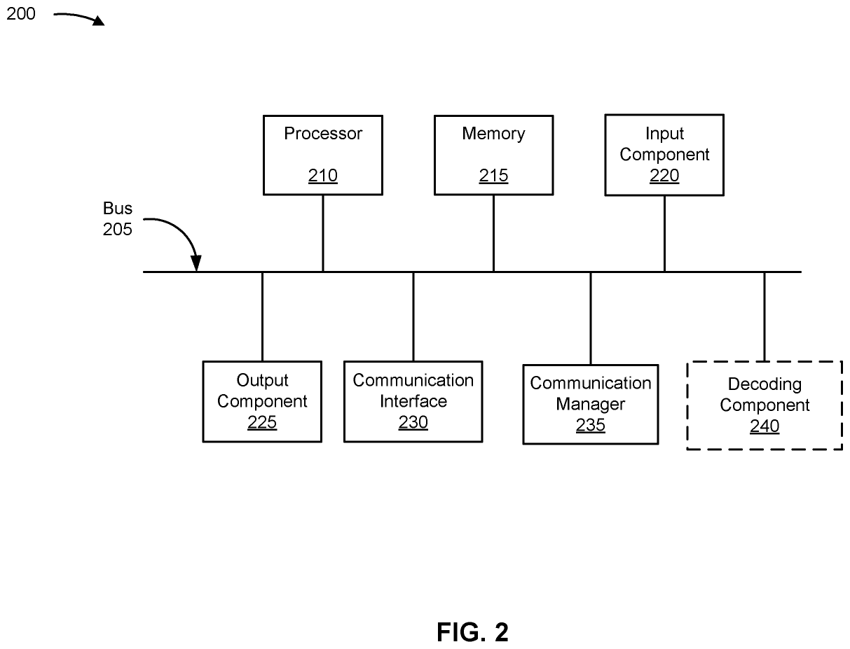

As used herein, “communication interface” refers to an interface that enables communication (e.g., wireless communication or wired communication) between a first network entity and a second network entity. A communication interface may include electronic circuitry that enables a network entity to transmit, receive, or otherwise perform the communication. A communication interface may include one or more components that are configured to enable communication between the first network entity and the second network entity. For example, a communication interface may include a transmission component, a reception component, and/or a transceiver, among other examples. Communication interfaces are described in more detail elsewhere herein, such as in connection with FIG. 2.

As described in more detail elsewhere herein, the network entity 102 may (e.g., the communication manager 110 may, or may cause the communication interface 112 to) receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT; receive, via a second frequency carrier, the second message of the multi-stage grant, wherein the second message indicates second information associated with the communication, and wherein the second frequency carrier is associated with a second RAT; and/or communicate, based on the second information, the communication. Additionally, or alternatively, the network entity 102 and/or the communication manager 110 may perform one or more other operations described herein.

As described in more detail elsewhere herein, the network entity 106 may (e.g., the communication manager 114 may, or may cause the communication interface 116 to) transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT; transmit, via a second frequency carrier, the second message of the multi-stage grant, wherein the second message indicates second information associated with the communication, and wherein the second frequency carrier is associated with a second RAT; and/or communicate, based on at least one of the first information or the second information, the communication. Additionally, or alternatively, the network entity 106 and/or the communication manager 114 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram of example components of an apparatus 200, in accordance with the present disclosure. The apparatus 200 may correspond to any one or more of the network entities 102, 104, and 106 or another network entity described herein. Additionally, or alternatively, any one or more of the network entities 102, 104, and 106 or another network entity described herein may include one or more apparatuses 200 and/or one or more components of the apparatus 200. For example, in some aspects, the apparatus 200 may include an apparatus (e.g., a device, a device component, a modem, a chip, and/or a set of device components, among other examples) that is configured to perform a wireless communication method, as described herein. As shown in FIG. 2, the apparatus 200 may include components such as a bus 205, a processor 210, a memory 215, an input component 220, an output component 225, a communication interface 230, a communication manager 235, and a decoding component 240. Any one or more of the components 205, 210, 215, 220, 225 230, 235, and/or 240 may be implemented in hardware, software, or a combination of hardware and software.

The bus 205 includes a component that permits communication among the components of the apparatus 200. The processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. In some aspects, the processor 210 includes one or more processors capable of being programmed to perform a function.

The memory 215 includes a random-access memory (RAM), a read only memory (ROM), and/or another type of dynamic or static storage device (e.g., a flash memory, a magnetic memory, and/or an optical memory) that stores information and/or instructions for use by the processor 210. The memory 215 may store other information and/or software related to the operation and use of the apparatus 200. For example, the memory 215 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium.

The input component 220 includes a component that permits the apparatus 200 to receive information, such as via user input. For example, the input component 220 may be associated with a user interface as described herein (e.g., to permit a user to interact with the one or more features of the apparatus 200). The input component 220 may include a capacitive touchscreen display that can receive user inputs. The input component 220 may include a keyboard, a keypad, a mouse, a button, a switch, and/or a microphone, among other examples. Additionally, or alternatively, the input component 220 may include a sensor for sensing information (e.g., a vision sensor, a location sensor, an accelerometer, a gyroscope, and/or an actuator, among other examples). In some aspects, the input component 220 may include a camera (e.g., a high-resolution camera and/or a low-resolution camera, among other examples). The output component 225 may include a component that provides output from the apparatus 200 (e.g., a display, a speaker, and/or one or more light-emitting diodes (LEDs), among other examples).

The communication interface 230 may include a transmission component and/or a reception component. For example, the communication interface 230 may include a transceiver and/or one or more separate receivers and/or transmitters that enable the apparatus 200 to communicate with other devices, such as via a wired connection, a wireless connection, or a combination of wired and wireless connections. In some aspects, the communication interface may include one or more radio frequency reflective elements and/or one or more radio frequency refractive elements. The communication interface 230 may permit the apparatus 200 to receive information from another apparatus and/or provide information to another apparatus. For example, the communication interface 230 may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

The communication manager 235 may include hardware, software, or a combination of hardware and software configured to cause the apparatus 200 to perform one or more communication tasks associated with the communication manager 110 and/or the communication interface 112 or the communication interface 230. Similarly, the communication manager 235 may include hardware, software, or a combination of hardware and software configured to cause the apparatus 200 to perform one or more communication tasks associated with the communication manager 114 and/or the communication interface 116 or the communication interface 230. In some aspects, the communication manager 235 may be, be similar to, include, or be included in, the communication manager 110 and/or the communication manager 114 depicted in FIG. 1. In some aspects, the communication manager 235 may include the processor 210, the memory 215, the input component 220, the output component 225, the communication interface 230, and/or the decoding component 240, and/or one or more aspects thereof. The decoding component 240 may include hardware, software, or a combination of hardware and software configured to cause the apparatus 200 to decode and/or otherwise receive a multi-stage grant, as described in more detail elsewhere herein (such as when the apparatus 200 is an entity that receives scheduling information from another entity). In other aspects, the apparatus 200 may include a scheduling component that is associated with generating and/or configuring the multi-stage grant (such as when the apparatus 200 is an entity that schedules communications for another entity).

As indicated above, FIG. 2 is provided as an example. Other examples may differ from what is described with regard to FIG. 2.

As described above, in some aspects, the network 108 depicted in FIG. 1 may include a cellular network that includes a RAT. While some aspects may be described herein using terminology commonly associated with a 5G or NR RAT, aspects of the present disclosure can be applied to other RATs, such as a 3G RAT, a 4G RAT, and/or a RAT subsequent to 5G (e.g., 6G).

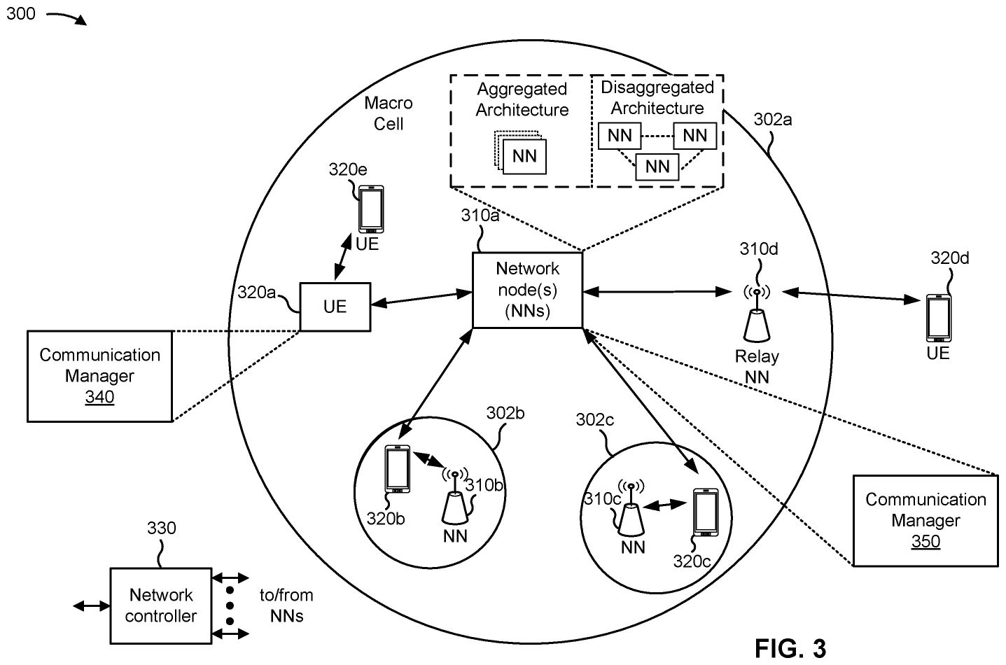

FIG. 3 is a diagram illustrating an example of a wireless network 300, in accordance with the present disclosure. The wireless network 300 may be or may include elements of a 4G (e.g., LTE) network, a 5G (e.g., NR) network, and/or, a 6G network, among other examples. The wireless network 300 may include one or more network nodes 310 (shown as a network node 310a, a network node 310b, a network node 310c, and a network node 310d), a UE 320 or multiple UEs 320 (shown as a UE 320a, a UE 320b, a UE 320c, a UE 320d, and a UE 320e), and/or other entities. A network node 310 is a network node that communicates with UEs 320. As shown, a network node 310 may include one or more network nodes. For example, a network node 310 may be an aggregated network node, meaning that the aggregated network node is configured to utilize a radio protocol stack that is physically or logically integrated within a single radio access network (RAN) node (e.g., within a single device or unit). As another example, a network node 310 may be a disaggregated network node (sometimes referred to as a disaggregated base station), meaning that the network node 310 is configured to utilize a protocol stack that is physically or logically distributed among two or more nodes (such as one or more CUs, one or more DUs, or one or more RUs).

In some examples, a network node 310 is or includes a network node that communicates with UEs 320 via a radio access link, such as an RU. In some examples, a network node 310 is or includes a network node that communicates with other network nodes 310 via a fronthaul link or a midhaul link, such as a DU. In some examples, a network node 310 is or includes a network node that communicates with other network nodes 310 via a midhaul link or a core network via a backhaul link, such as a CU. In some examples, a network node 310 (such as an aggregated network node 310 or a disaggregated network node 310) may include multiple network nodes, such as one or more RUs, one or more CUs, and/or one or more DUs. A network node 310 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 310 may be interconnected to one another or to one or more other network nodes 310 in the wireless network 300 through various types of fronthaul, midhaul, and/or backhaul interfaces, such as a direct physical connection, an air interface, or a virtual network, using any suitable transport network.

In some examples, a network node 310 may provide communication coverage for a particular geographic area. In the Third Generation Partnership Project (3GPP), the term “cell” can refer to a coverage area of a network node 310 and/or a network node subsystem serving this coverage area, depending on the context in which the term is used. A network node 310 may provide communication coverage for a macro cell, a pico cell, a femto cell, and/or another type of cell. A macro cell may cover a relatively large geographic area (e.g., several kilometers in radius) and may allow unrestricted access by UEs 320 with service subscriptions. A pico cell may cover a relatively small geographic area and may allow unrestricted access by UEs 320 with service subscriptions. A femto cell may cover a relatively small geographic area (e.g., a home) and may allow restricted access by UEs 320 having association with the femto cell (e.g., UEs 320 in a closed subscriber group (CSG)). A network node 310 for a macro cell may be referred to as a macro network node. A network node 310 for a pico cell may be referred to as a pico network node. A network node 310 for a femto cell may be referred to as a femto network node or an in-home network node. In the example shown in FIG. 3, the network node 310a may be a macro network node for a macro cell 302a, the network node 310b may be a pico network node for a pico cell 302b, and the network node 310c may be a femto network node for a femto cell 302c. A network node may support one or multiple (e.g., three) cells. In some examples, a cell may not necessarily be stationary, and the geographic area of the cell may move according to the location of a network node 310 that is mobile (e.g., a mobile network node).

In some aspects, the terms “base station” or “network entity” may refer to an aggregated base station, a disaggregated base station, an IAB node, a relay node, or one or more components thereof. For example, in some aspects, “base station” or “network entity” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the network node 310. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 300 may include one or more relay stations. A relay station is a network node that can receive a transmission of data from an upstream node (e.g., a network node 310 or a UE 320) and send a transmission of the data to a downstream node (e.g., a UE 320 or a network node 310). A relay station may be a UE 320 that can relay transmissions for other UEs 320. In the example shown in FIG. 3, the network node 310d (e.g., a relay network node) may communicate with the network node 310a (e.g., a macro network node) and the UE 320d in order to facilitate communication between the network node 310a and the UE 320d. A network node 310 that relays communications may be referred to as a relay station, a relay base station, a relay network node, a relay node, a relay, or the like.

The wireless network 300 may be a heterogeneous network that includes network nodes 310 of different types, such as macro network nodes, pico network nodes, femto network nodes, relay network nodes, or the like. These different types of network nodes 310 may have different transmit power levels, different coverage areas, and/or different impacts on interference in the wireless network 300. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 330 may couple to or communicate with a set of network nodes 310 and may provide coordination and control for these network nodes 310. The network controller 330 may communicate with the network nodes 310 via a backhaul communication link or a midhaul communication link. The network nodes 310 may communicate with one another directly or indirectly via a wireless or wireline backhaul communication link. In some aspects, the network controller 330 may be a CU or a core network device, or may include a CU or a core network device.

For example, in some aspects, the wireless network 300 may be, include, or be included in a wireless backhaul network, sometimes referred to as an IAB network. In an IAB network, at least one network entity (e.g., network node 310) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations or IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 320) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target network entity (e.g., a UE and/or a base station). In this way, inter-link interference may be reduced.

An IAB network may include an IAB donor that connects to a core network via a wired connection (e.g., a wireline backhaul). For example, an Ng interface of an IAB donor may terminate at a core network. Additionally, or alternatively, an IAB donor may connect to one or more devices of the core network that provide a core access and mobility management function (AMF). In some aspects, an IAB donor may include a network node 310, such as an anchor base station. An IAB donor may include a CU, which may perform access node controller (ANC) functions and/or AMF functions. The CU may configure a DU of the IAB donor and/or may configure one or more IAB nodes (e.g., a mobile termination (MT) function and/or a DU function of an IAB node) that connect to the core network via the IAB donor. Thus, a CU of an IAB donor may control and/or configure the entire IAB network (or a portion thereof) that connects to the core network via the IAB donor, such as by using control messages and/or configuration messages (e.g., a radio resource control (RRC) configuration message or an F1 application protocol (F1AP) message).

The MT functions of an IAB node (e.g., a child node) may be controlled and/or scheduled by another IAB node (e.g., a parent node of the child node) and/or by an IAB donor. The DU functions of an IAB node (e.g., a parent node) may control and/or schedule other IAB nodes (e.g., child nodes of the parent node) and/or UEs 320. Thus, a DU may be referred to as a scheduling node or a scheduling component, and an MT may be referred to as a scheduled node or a scheduled component. In some aspects, an IAB donor may include DU functions and not MT functions. That is, an IAB donor may configure, control, and/or schedule communications of IAB nodes and/or UEs 320. A UE 320 may include only MT functions, and not DU functions. That is, communications of a UE 320 may be controlled and/or scheduled by an IAB donor and/or an IAB node (e.g., a parent node of the UE 320).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor or an IAB node, and a child node may be an IAB node or a UE 320. Communications of an MT function of a child node may be controlled and/or scheduled by a parent node of the child node.

A link between a UE 320 and an IAB donor, or between a UE 320 and an IAB node, may be referred to as an access link. An access link may be a wireless access link that provides a UE 320 with radio access to a core network via an IAB donor, and optionally via one or more IAB nodes. Thus, the wireless network 300 may be referred to as a multi-hop network or a wireless multi-hop network.

A link between an IAB donor and an IAB node or between two IAB nodes may be referred to as a backhaul link. A backhaul link may be a wireless backhaul link that provides an IAB node with radio access to a core network via an IAB donor, and optionally via one or more other IAB nodes. In an IAB network, network resources for wireless communications (e.g., time resources, frequency resources, and/or spatial resources) may be shared between access links and backhaul links. In some aspects, a backhaul link may be a primary backhaul link or a secondary backhaul link (e.g., a backup backhaul link). In some aspects, a secondary backhaul link may be used if a primary backhaul link fails, becomes congested, and/or becomes overloaded, among other examples.

The UEs 320 may be dispersed throughout the wireless network 300, and each UE 320 may be stationary or mobile. A UE 320 may include, for example, an access terminal, a terminal, a mobile station, and/or a subscriber unit. A UE 320 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 320 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 320 may be considered Internet-of-Things (IoT) devices, and/or may be implemented as NB-IoT (narrowband IoT) devices. Some UEs 320 may be considered a Customer Premises Equipment. A UE 320 may be included inside a housing that houses components of the UE 320, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

Some network nodes may have a reduced feature set compared to other network nodes. A network node with a reduced feature set may be referred to as a reduced capability (RedCap) node, a low-tier node, an NR-Lite node, an IoT node, an ambient IoT node, a passive node, a terminal (e.g., a radio frequency identification (RFID) device, a tag, or a similar device), and/or an energy-harvesting-capable node, among other examples. For example, a node with a reduced feature set may support a lower maximum modulation and coding scheme (MCS) than other nodes (e.g., quadrature phase shift keying (QPSK) or the like as compared to 256-quadrature amplitude modulation (QAM) or the like), may support a lower maximum transmit power, may have a less advanced beamforming capability (e.g., may not be capable of forming as many beams as other nodes), may require a longer processing time, may include less hardware (e.g., fewer antennas, fewer RF components, fewer transmit antennas, and/or fewer receive antennas), and/or may not be capable of communicating on as wide of a maximum bandwidth, among other examples.

In general, any number of wireless networks 300 may be deployed in a given geographic area. Each wireless network 300 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 320 may communicate directly using one or more sidelink channels (e.g., without using a network node 310 as an intermediary to communicate with one another). For example, the UE 320a may communicate with a UE 320e via one or more sidelink channels. For example, the UEs 320 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 320 may perform scheduling operations, resource selection operations, and/or other operations described elsewhere herein as being performed by the network node 310.

Devices of the wireless network 300 may communicate using the electromagnetic spectrum, which may be subdivided by frequency or wavelength into various classes, bands, channels, or the like. For example, devices of the wireless network 300 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 may be referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz).

Each of these higher frequency bands falls within the EHF band.

With the above examples in mind, unless specifically stated otherwise, the term “sub-6 GHz” or the like, if used herein, may broadly represent frequencies that may be less than 6 GHz, may be within FR1, or may include mid-band frequencies. Further, unless specifically stated otherwise, the term “millimeter wave” or the like, if used herein, may broadly represent frequencies that may include mid-band frequencies, may be within FR2, FR4, FR4-a or FR4-1, and/or FR5, or may be within the EHF band. The frequencies included in these operating bands (e.g., FR1, FR2, FR3, FR4, FR4-a, FR4-1, and/or FR5) may be modified, and techniques described herein are applicable to those modified frequency ranges.

As described above, in some aspects, a network entity (e.g., the network entity 102, 104, and/or 106 depicted in FIG. 1) may be implemented in a wireless communication environment. For example, in some aspects, the network node may be implemented as a UE, a base station, relay device, and/or TRP, among other examples. In some such aspects, as shown in FIG. 3, the UE 320a may include a communication manager 340 and/or a transceiver and the network node 310a may include a communication manager 350 and/or a transceiver. In some aspects, the communication manager 340 and/or 350 may be, be similar to, include, or be included in, the communication manager 110 and/or the communication manager 114 depicted in FIG. 1 and/or the communication manager 235 depicted in FIG. 2. In some aspects, the transceiver(s) may be, be similar to, include, or be included in, the communication interface 112 and/or the communication interface 116 depicted in FIG. 1. In some aspects, the transceiver(s) may include, or be included in, the communication interface 230 depicted in FIG. 2.

In some aspects, the UE 320 may include a communication manager 340. As described in more detail elsewhere herein, the communication manager 340 may receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT; receive, via a second frequency carrier, the second message of the multi-stage grant, wherein the second message indicates second information associated with the communication, and wherein the second frequency carrier is associated with a second RAT; and/or communicate, based on the second information, the communication. Additionally, or alternatively, the communication manager 340 may perform one or more other operations described herein.

In some aspects, the network node 310 may include a communication manager 350. As described in more detail elsewhere herein, the communication manager 350 may transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT; transmit, via a second frequency carrier, the second message of the multi-stage grant, wherein the second message indicates second information associated with the communication, and wherein the second frequency carrier is associated with a second RAT; and/or communicate, based on at least one of the first information or the second information, the communication. Additionally, or alternatively, the communication manager 350 may perform one or more other operations described herein.

As indicated above, FIG. 3 is provided as an example. Other examples may differ from what is described with regard to FIG. 3.

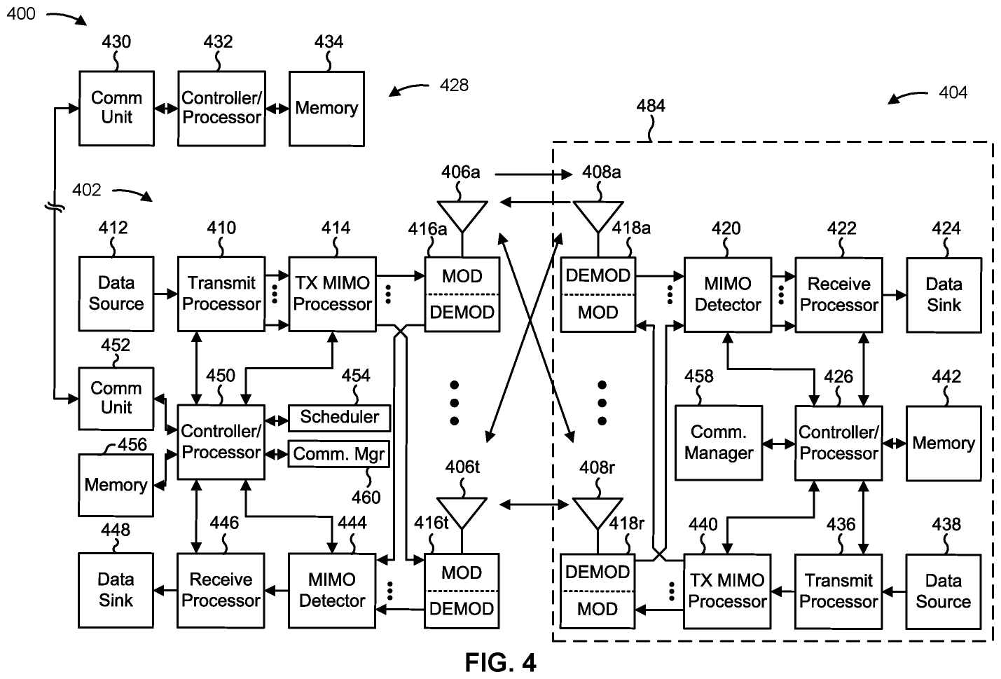

FIG. 4 is a diagram illustrating an environment 400 including a network entity 402 in wireless communication with a network entity 404 (e.g., via a network such as the network 108 depicted in FIG. 1 and/or the wireless network 300 depicted in FIG. 3), in accordance with the present disclosure. The network entity 402 may be equipped with a set of antennas 406a through 406t, such as T antennas (T≥1). The network entity 404 may be equipped with a set of antennas 408a through 408r, such as R antennas (R≥1).

At the network entity 402, a transmit processor 410 may receive data, from a data source 412, intended, or otherwise destined, for the network entity 404 (or a set of network entities 404). The transmit processor 410 may select one or more MCSs for the network entity 404 based on one or more channel quality indicators (CQIs) received from that network entity 404. The network entity 402 may process (e.g., encode and modulate) the data for the network entity 404 based on the MCS(s) selected for the network entity 404 and may provide data symbols for the network entity 404. The transmit processor 410 may process system information (e.g., for semi-static resource partitioning information (SRPI)) and control information (e.g., CQI requests, grants, and/or upper layer signaling) and provide overhead symbols and control symbols. The transmit processor 410 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 414 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 416a through 416t (e.g., T modems). For example, each output symbol stream may be provided to a modulator component (shown as MOD) of a modem of the set of modems 416a through 416t. Each modem of the set of modems 416a through 416t may use a respective modulator component to process a respective output symbol stream (e.g., for OFDM) to obtain an output sample stream. Each modem of the set of modems 416a through 416t may further use a respective modulator component to process (e.g., convert to analog, amplify, filter, and/or upconvert) the output sample stream to obtain a signal. One or more modems of the set of modems 416a through 416t may transmit a set of signals (e.g., T signals) via a corresponding antenna of the set of antennas 406a through 406t. The signal may include, for example, a downlink signal.

At the network entity 404, one or more antennas of the set of antennas 408a through 408r may receive the signals from the network entity 402 and/or network nodes and may provide a set of received signals (e.g., R received signals) to one or more modems of a set of modems 418a through 418r (e.g., R modems). For example, each received signal may be provided to a demodulator component (shown as DEMOD) of a respective modem of the set of modems 418a through 418r. Each modem of the set of modems 418a through 418r may use a respective demodulator component to condition (e.g., filter, amplify, downconvert, and/or digitize) a received signal to obtain input samples. Each modem of the set of modems 418a through 418r may use a demodulator component to further process the input samples (e.g., for OFDM) to obtain received symbols. A MIMO detector 420 may obtain received symbols from one or more modems of the set of modems 418a through 418r, may perform MIMO detection on the received symbols if applicable, and may provide detected symbols.

A receive processor 422 may process (e.g., demodulate and decode) the detected symbols, may provide decoded data for the network entity 404 to a data sink 424, and may provide decoded control information and system information to a controller/processor 426. The term “controller/processor” may refer to one or more controllers, one or more processors, or a combination thereof. The controller/processor 426 may be, be similar to, include, or be included in, the processor 210 depicted in FIG. 2. The controller/processor 426 may determine a reference signal received power (RSRP) parameter, a received signal strength indicator (RSSI) parameter, a reference signal received quality (RSRQ) parameter, and/or a CQI parameter, among other examples.

A network controller 428 may include a communication unit 430, a controller/processor 432, and a memory 434. The network controller 428 may be, be similar to, include, or be included in, the network controller 330 depicted in FIG. 3. The network controller 428 may include, for example, one or more devices in a core network. The network controller 428 may communicate with the network entity 402 via the communication unit 430.

One or more antennas (e.g., antennas 406a through 406t and/or antennas 408a through 408r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings, such as a housing 484), a set of coplanar antenna elements, a set of non-coplanar antenna elements, and/or one or more antenna elements coupled to one or more transmission and/or reception components, such as one or more components of FIG. 4.

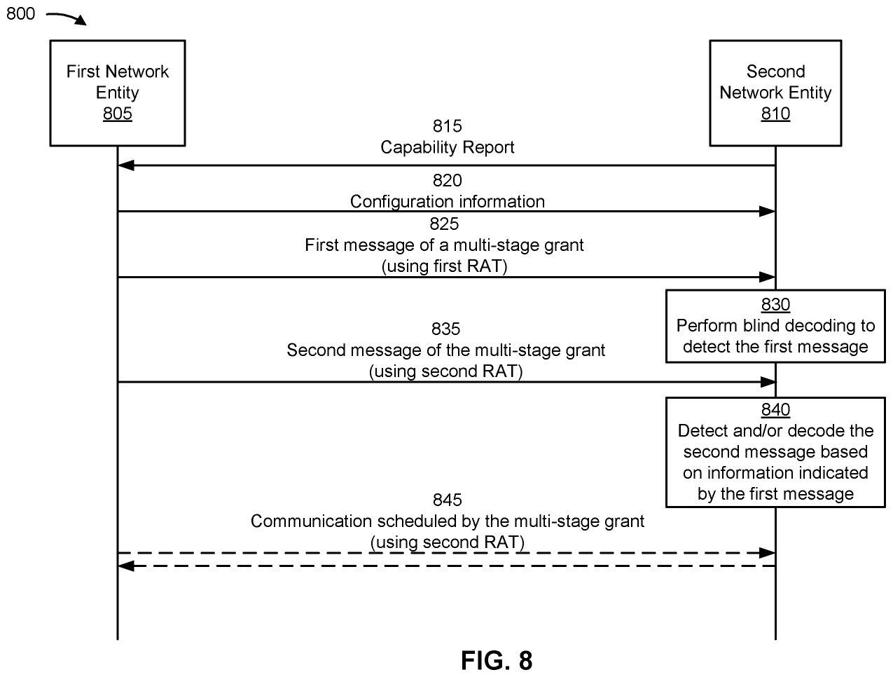

Similarly, at the network entity 404, a transmit processor 436 may receive and process data from a data source 438 and control information (e.g., for reports that include RSRP, RSSI, RSRQ, and/or CQI) from the controller/processor 426. The transmit processor 436 may generate reference symbols for one or more reference signals. The symbols from the transmit processor 436 may be precoded by a TX MIMO processor 440 if applicable, and further processed by one or more of the set of modems 418a through 418r (e.g., for DFT-s-OFDM or CP-OFDM), and transmitted to the network entity 402. In some examples, each modem of the set of modems 418a through 418r of the network entity 404 may include a modulator and a demodulator. The network entity 404 may include a communication manager 458. The communication manager 458 may be, or may be similar to, the communication manager 110, the communication manager 114, the communication manager 235, the communication manager 340, and/or the communication manager 350. In some examples, the network entity 404 includes a transceiver. The transceiver may include any combination of the antenna(s) 408a through 408r, the modem(s) 418a through 418r, the MIMO detector 420, the receive processor 422, the transmit processor 436, and/or the TX MIMO processor 440. The transceiver may be, be similar to, include, or be included in, the communication interface 112 and/or the communication interface 116 depicted in FIG. 1 and/or the communication interface 230 depicted in FIG. 2. The transceiver may be used by a processor (e.g., the controller/processor 426) and/or a memory 442 to perform aspects of any of the methods described herein (e.g., with reference to FIGS. 8-13).

At the network entity 402, the signals from network entity 404 and/or other network nodes may be received by one or more antennas of the set of antennas 406a through 406t, processed by one or more modems of the set of modems 416a through 416t (e.g., a demodulator component, shown as DEMOD), detected by a MIMO detector 444 if applicable, and further processed by a receive processor 446 to obtain decoded data and control information sent by the network entity 404. The receive processor 446 may provide the decoded data to a data sink 448 and provide the decoded control information to a controller/processor 450. The network entity 402 may include a communication unit 452 and may communicate with the network controller 428 via the communication unit 452. The network entity 402 may include a communication manager 460. The communication manager 460 may be, or may be similar to, the communication manager 110, the communication manager 114, the communication manager 235, the communication manager 340, and/or the communication manager 350. The network entity 402 may include a scheduler 454 to schedule one or more network entities 404 for downlink and/or uplink communications. In some examples, one or more modems of the set of modem 416a through 416t of the network entity 402 may include a modulator and a demodulator. In some examples, the network entity 402 includes a transceiver. The transceiver may include any combination of the antenna(s) 406a through 406t, the modem(s) 416a through 416t, the MIMO detector 444, the receive processor 446, the transmit processor 410, and/or the TX MIMO processor 414. The transceiver may be, be similar to, include, or be included in, the communication interface 112 and/or the communication interface 116 depicted in FIG. 1 and/or the communication interface 230 depicted in FIG. 2. The transceiver may be used by a processor (e.g., the controller/processor 450) and a memory 456 to perform aspects of any of the methods described herein (e.g., with reference to FIGS. 8-13).

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

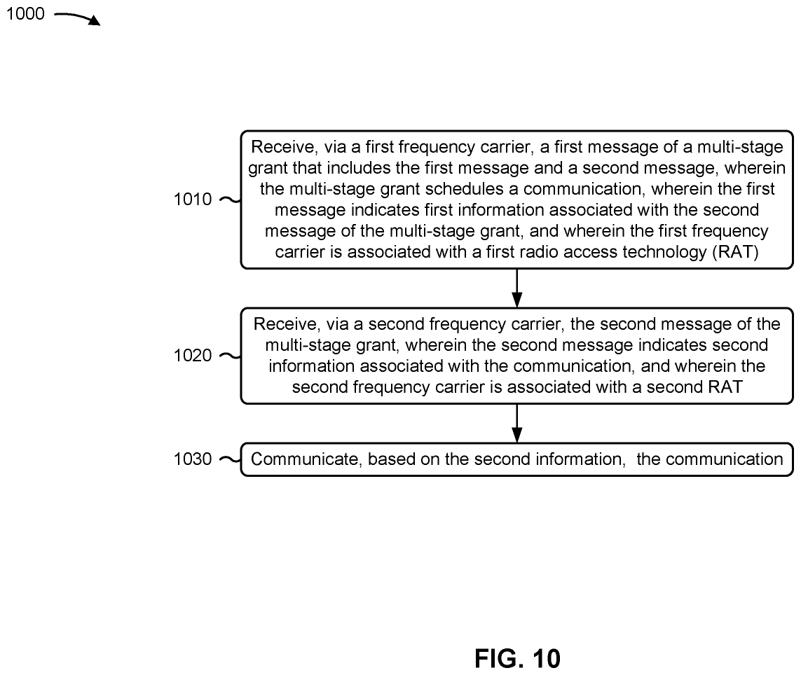

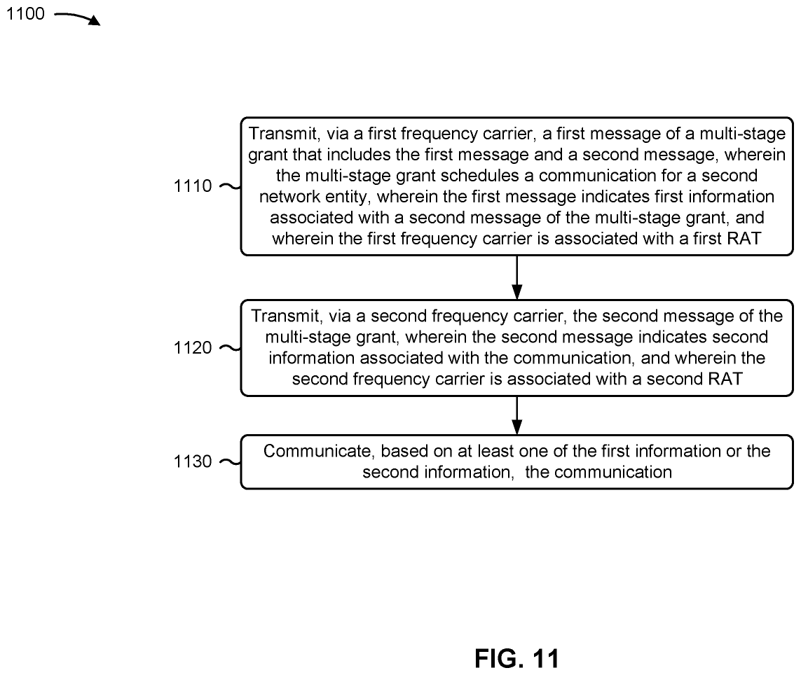

The controller/processor 450 of the network entity 402, the controller/processor 426 of the network entity 404, and/or any other component(s) of FIG. 4 may perform one or more techniques associated with multi-stage grant for multi-RAT spectrum sharing, as described in more detail elsewhere herein. For example, the controller/processor 450 of the network entity 402, the controller/processor 426 of the network entity 404, and/or any other component(s) of FIG. 4 may perform or direct operations of, for example, process 1000 of FIG. 10, process 1100 of FIG. 11, and/or other processes as described herein. The memory 442 and the memory 456 may store data and program codes for the network entity 402 and the network entity 404, respectively. In some examples, the memory 442 and/or the memory 456 may include a non-transitory computer-readable medium storing one or more instructions (e.g., code and/or program code) for wireless communication. For example, the one or more instructions, when executed (e.g., directly, or after compiling, converting, and/or interpreting) by one or more respective processors of the network entity 402 and/or the network entity 404, may cause the one or more processors, the network entity 404, and/or the network entity 402 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a first network entity (e.g., the network entity 402 or the network entity 404) includes means for receiving, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT; means for receiving, via a second frequency carrier, the second message of the multi-stage grant, wherein the second message indicates second information associated with the communication, and wherein the second frequency carrier is associated with a second RAT; and/or means for communicating, based on the second information, the communication. In some aspects, the means for the first network entity to perform operations described herein may include, for example, one or more of communication manager 458, antenna 408, modem 418, MIMO detector 420, receive processor 422, transmit processor 436, TX MIMO processor 440, controller/processor 426, memory 442, the communication interface 112, the communication interface 116, and/or the communication interface 230, among other examples.

In some aspects, a first network entity (e.g., the network entity 402 or the network entity 404) includes means for transmitting, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT; means for transmitting, via a second frequency carrier, the second message of the multi-stage grant, wherein the second message indicates second information associated with the communication, and wherein the second frequency carrier is associated with a second RAT; and/or means for communicating, based on at least one of the first information or the second information, the communication. In some aspects, the means for the first network entity to perform operations described herein may include, for example, one or more of communication manager 460, transmit processor 410, TX MIMO processor 414, modem 416, antenna 406, MIMO detector 444, receive processor 446, controller/processor 450, memory 456, scheduler 454, the communication interface 112, the communication interface 116, and/or the communication interface 230, among other examples.

While blocks in FIG. 4 are illustrated as distinct components, the functions described above with respect to the blocks may be implemented in a single hardware, software, or combination component or in various combinations of components. For example, the functions described with respect to the transmit processor 436, the receive processor 422, and/or the TX MIMO processor 440 may be performed by or under the control of the controller/processor 426. Any number of other combination of various combinations of components depicted in FIG. 4 may be considered to be within the ambit of the present disclosure.

As indicated above, FIG. 4 is provided as an example. Other examples may differ from what is described with regard to FIG. 4.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network entities. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As used herein, a first network entity “outputting” or “transmitting” a communication to a second network entity may refer to a direct transmission (for example, from the first network entity to the second network entity) or an indirect transmission via one or more other network entities or devices. For example, if the first network entity is a DU, an indirect transmission to the second network entity may include the DU outputting or transmitting a communication to an RU and the RU transmitting the communication to the second network entity, or may include causing the RU to transmit the communication (e.g., triggering transmission of a physical layer reference signal). Similarly, the second network entity “transmitting” a communication to the first network entity may refer to a direct transmission (e.g., from the second network entity to the first network entity) or an indirect transmission via one or more other network entities or devices. For example, if the first network entity is a DU, an indirect transmission to the first network entity may include the second network entity transmitting a communication to an RU and the RU transmitting the communication to the DU. Similarly, the first network entity “obtaining” a communication may refer to receiving a transmission carrying the communication directly (for example, from the second network entity to the first network entity) or receiving the communication (or information derived from reception of the communication) via one or more other network entities or devices.

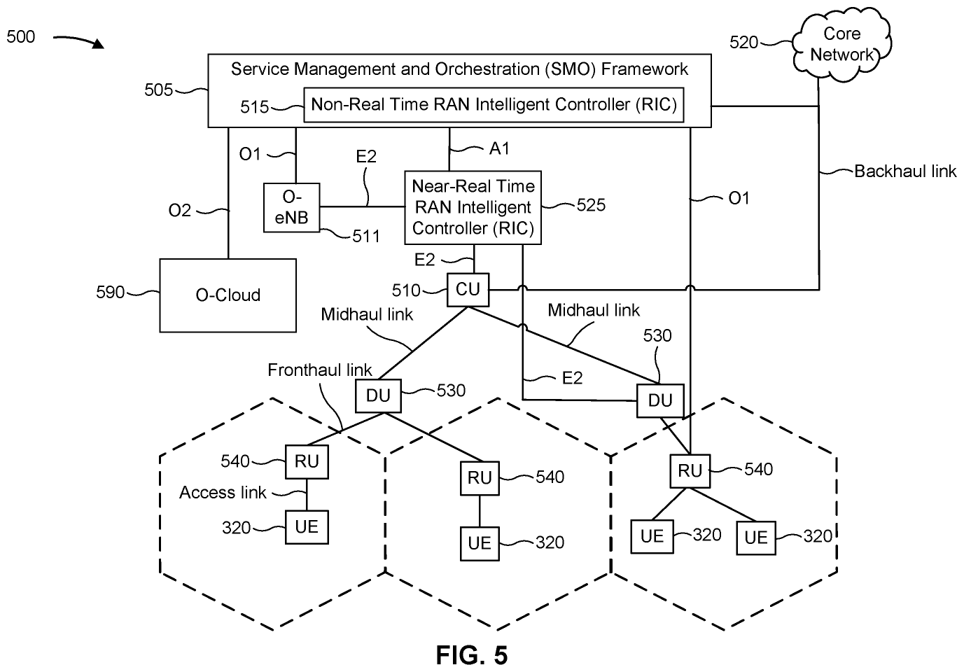

FIG. 5 is a diagram illustrating an example disaggregated base station architecture 500, in accordance with the present disclosure. The disaggregated base station architecture 500 may include a CU 510 that can communicate directly with a core network 520 via a backhaul link, or indirectly with the core network 520 through one or more disaggregated control units (such as a Near-RT RIC 525 via an E2 link, or a Non-RT RIC 515 associated with a Service Management and Orchestration (SMO) Framework 505, or both). A CU 510 may communicate with one or more DUs 530 via respective midhaul links, such as through F1 interfaces. Each of the DUs 530 may communicate with one or more RUs 540 via respective fronthaul links. Each of the RUs 540 may communicate with one or more UEs 320 via respective RF access links. In some implementations, a UE 320 may be simultaneously served by multiple RUs 540.

Each of the units, including the CUs 510, the DUs 530, the RUs 540, as well as the Near-RT RICs 525, the Non-RT RICs 515, and the SMO Framework 505, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 510 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 510. The CU 510 may be configured to handle user plane functionality (for example, Central Unit-User Plane (CU-UP) functionality), control plane functionality (for example, Central Unit-Control Plane (CU-CP) functionality), or a combination thereof. In some implementations, the CU 510 can be logically split into one or more CU-UP units and one or more CU-CP units. A CU-UP unit can communicate bidirectionally with a CU-CP unit via an interface, such as the E1 interface when implemented in an O-RAN configuration. The CU 510 can be implemented to communicate with a DU 530, as necessary, for network control and signaling.

Each DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 530 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 530, or with the control functions hosted by the CU 510.

Each RU 540 may implement lower-layer functionality. In some deployments, an RU 540, controlled by a DU 530, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 540 can be operated to handle over the air (OTA) communication with one or more UEs 320. In some implementations, real-time and non-real-time aspects of control and user plane communication with the RU(s) 540 can be controlled by the corresponding DU 530. In some scenarios, this configuration can enable each DU 530 and the CU 510 to be implemented in a cloud-based RAN architecture, such as a vRAN architecture.

The SMO Framework 505 may be configured to support RAN deployment and provisioning of non-virtualized and virtualized network elements. For non-virtualized network elements, the SMO Framework 505 may be configured to support the deployment of dedicated physical resources for RAN coverage requirements, which may be managed via an operations and maintenance interface (such as an O1 interface). For virtualized network elements, the SMO Framework 505 may be configured to interact with a cloud computing platform (such as an open cloud (O-Cloud) platform 590) to perform network element life cycle management (such as to instantiate virtualized network elements) via a cloud computing platform interface (such as an O2 interface). Such virtualized network elements can include, but are not limited to, CUs 510, DUs 530, RUs 540, non-RT RICs 515, and Near-RT RICs 525. In some implementations, the SMO Framework 505 can communicate with a hardware aspect of a 4G RAN, such as an open eNB (O-eNB) 511, via an O1 interface. Additionally, in some implementations, the SMO Framework 505 can communicate directly with each of one or more RUs 540 via a respective O1 interface. The SMO Framework 505 also may include a Non-RT RIC 515 configured to support functionality of the SMO Framework 505.

The Non-RT RIC 515 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 525. The Non-RT RIC 515 may be coupled to or communicate with (such as via an A1 interface) the Near-RT RIC 525. The Near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the Near-RT RIC 525.

In some implementations, to generate AI/ML models to be deployed in the Near-RT RIC 525, the Non-RT RIC 515 may receive parameters or external enrichment information from external servers. Such information may be utilized by the Near-RT RIC 525 and may be received at the SMO Framework 505 or the Non-RT RIC 515 from non-network data sources or from network functions. In some examples, the Non-RT RIC 515 or the Near-RT RIC 525 may be configured to tune RAN behavior or performance. For example, the Non-RT RIC 515 may monitor long-term trends and patterns for performance and employ AI/ML models to perform corrective actions through the SMO Framework 505 (such as reconfiguration via an O1 interface) or via creation of RAN management policies (such as A1 interface policies).

As indicated above, FIG. 5 is provided as an example. Other examples may differ from what is described with regard to FIG. 5.

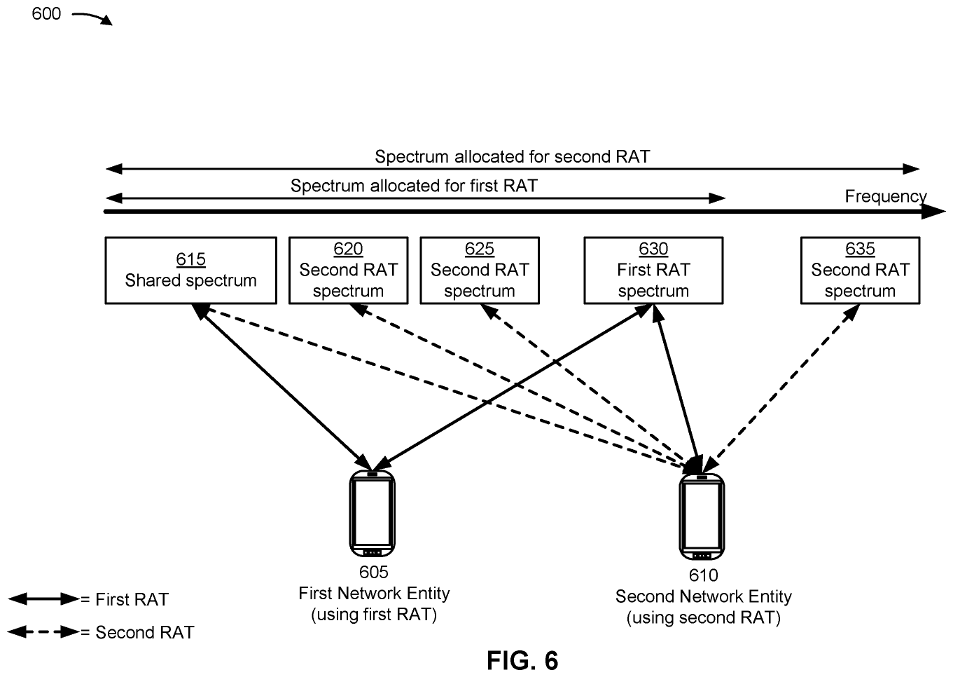

FIG. 6 is a diagram of an example 600 associated with multi-RAT spectrum sharing (MRSS), in accordance with the present disclosure. As shown in FIG. 6, a first RAT and a second RAT may coexist on shared frequency domain resources. For example, network entities may communicate via the first RAT and the second RAT using one or more shared frequency domain resources (e.g., one or more shared spectrums, shared frequency bands, shared carriers, and/or shared frequency ranges).

In some examples, the second RAT may be a RAT subsequent to the first RAT (e.g., the first RAT may be a “legacy” RAT and the second RAT may be a “new” RAT). In some examples, a frequency range allocated for the second RAT may include at least a portion of a frequency range allocated for the first RAT and one or more additional frequency domain resources outside of the frequency range allocated for the first RAT. The one or more additional frequency domain resources outside of the frequency range allocated for the first RAT may be associated with a higher frequency than the frequency range allocated for the first RAT. For example, the first RAT may be a 5G RAT or an NR RAT and the second RAT may be a 6G RAT. As another example, the first RAT may be a 4G RAT and the second RAT may be the 6G RAT. As another example, the first RAT may be the 6G RAT and the second RAT may be a RAT subsequent to 6G (e.g., a 7G RAT).

Some network entities deployed in a wireless network may be configured to operate using the first RAT. Additionally, other network entities deployed in the wireless network may be configured to operate using the second RAT (e.g., the first RAT and the second RAT may coexist in the wireless network). For example, a first network entity 605 (e.g., a first UE or another network entity) may be configured to use the first RAT. A second network entity 610 (e.g., a second UE or another network entity) may be configured to use the second RAT.

As shown in FIG. 6, one or more spectrums may be allocated for the first RAT and/or the second RAT (e.g., by a network operator associated with the wireless network). For example, a shared spectrum 615 may be allocated for both the first RAT and the second RAT. The shared spectrum 615 may also be referred to as a shared band, a multi-RAT shared spectrum, and/or a multi-RAT shared band, among other examples. In some examples, the shared spectrum 615 may be included in a low-band and/or mid-band frequency range. For example, the shared spectrum 615 may be included in FR1, FR2, and/or a millimeter wave band, among other examples.

A spectrum 620, a spectrum 625, and a spectrum 635 may be allocated for the second RAT (e.g., only the second RAT and not the first RAT). A spectrum 630 may be allocated for the first RAT (e.g., only the first RAT and not the second RAT). The first network entity 605 may communicate using the shared spectrum 615 and/or the spectrum 630. The second network entity 610 may communicate using the shared spectrum 615, the spectrum 620, the spectrum 625, the spectrum 630, and/or the spectrum 635 (e.g., the second network entity 610 may be capable of aggregating all available spectrums for the first RAT and the second RAT).

The shared spectrum 615 may include one or more carrier frequencies (e.g., operating frequencies or frequency bands) that are available for both the first RAT and the second RAT. A network entity (e.g., the first network entity 605 or the second network entity 610) may be unaware of whether another network entity (e.g., another UE) is using the shared spectrum 615 at the same time as the network entity (e.g., in a similar manner as a shared or unlicensed frequency band). However, unlike when operating using a shared or unlicensed frequency band, when operating using the shared spectrum 615 the network entity may not contend against other devices for channel access before communicating (e.g., transmitting) on the shared spectrum 615 (e.g., in some shared or unlicensed frequency bands, a transmitting device may contend against other devices for channel access before transmitting on the shared or unlicensed band(s) to reduce and/or prevent collisions). For example, one or more control entities (e.g., a base station, a CU, a DU, and/or an RU) may schedule and/or allocate resources for network entities using the shared spectrum 615 to reduce and/or prevent collisions. For example, a network entity (e.g., the first network entity 605 or the second network entity 610) using the shared spectrum 615 may communicate based on, or otherwise associated with, a scheduling grant received by the network entity (e.g., without performing a channel access procedure, such as a listen-before-talk procedure). This increases flexibility for network entity scheduling, improves network resource utilization, and/or improves access to the wireless network by enabling the shared spectrum 615 to be used for both the first RAT and the second RAT without a network entity performing a channel access procedure to communicate using the shared spectrum 615.

As indicated above, FIG. 6 is provided as an example. Other examples may differ from what is described with regard to FIG. 6.

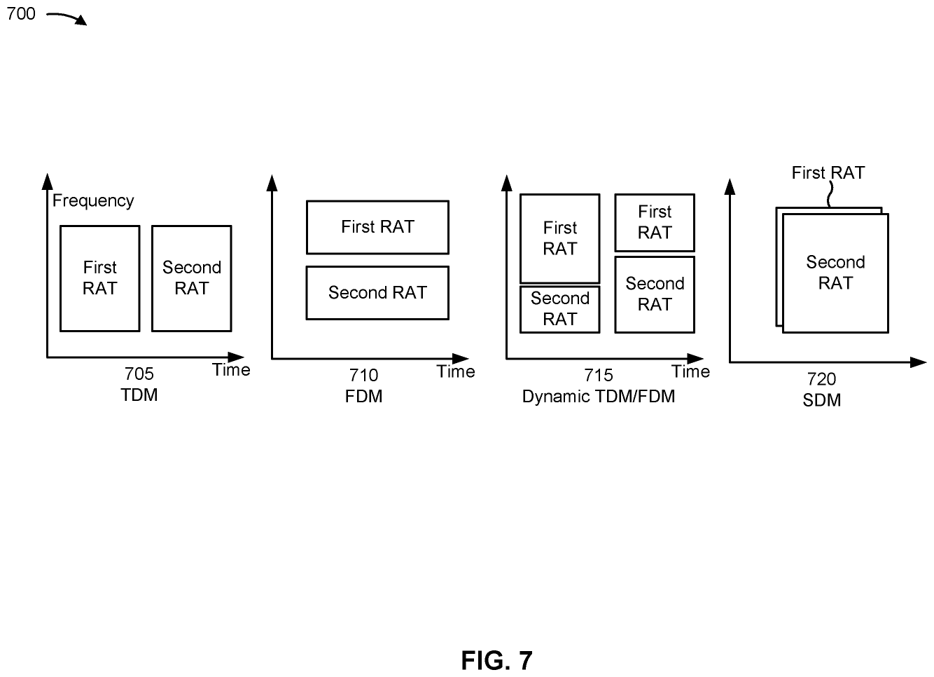

FIG. 7 is a diagram of an example 700 associated with MRSS, in accordance with the present disclosure.

In some network deployments, cells may be deployed that operate using high frequency bands, such as the EHF band, FR3, FR4, FR5, a sub-terahertz (sub-THz) band (e.g., which may include frequencies that are multiple hundreds of GHz, such as 100 GHz-300 GHz), and/or other high frequency bands. These high-band cells may provide increased data capacity and/or increased throughput for UEs (e.g., because of an increased bandwidth associated with the high frequency bands). For example, network entities associated with a high-band cell may communicate using a larger bandwidth size, such as a 7.5 GHz bandwidth, among other examples. Communicating using the larger bandwidth size may result in an increased throughput for communications between the network entities.

For example, the network deployment may utilize access distributed RUs and/or repeaters (e.g., in areas with high data volume demand potential). In some examples, the RUs and/or repeaters may provide a high capacity channel for a high frequency RAT (such as the second RAT described in connection with FIG. 6). The RUs and/or repeaters may provide a local spot-based coverage with increased capacity under a wider cell using a lower frequency band (e.g., an FR1 or FR2 based cell) coverage range. For example, a cell using a lower frequency band may provide a network entity with core functionality (e.g., control signaling, system information signaling, paging, synchronization signal block (SSB) signaling, coarse synchronization, and/or coarse beam management) and a cell using the higher frequency band may provide the network entity with improved throughput. In some examples, higher frequency RAT communication may be supported via a secondary cell (SCell) (or secondary component carrier) while a corresponding primary cell (PCell) (or primary component carrier) may be on a lower frequency range (e.g., FR1/FR2/FR4) and the PCell may provide master cell connectivity to support the higher frequency RAT communication (which may be with a burst activity pattern).

As shown in FIG. 7, and by reference number 705, the network deployment may utilize time division multiplexing (TDM) to allocate time domain resources and/or frequency domain resources to multiple RATs (e.g., where the first RAT and the second RAT use shared frequency domain resources and different time domain resources). As another example, and as shown by reference number 710, the network deployment may utilize frequency division multiplexing (FDM) to allocate time domain resources and/or frequency domain resources to multiple RATs (e.g., where the first RAT and the second RAT use shared time domain resources and different frequency domain resources). As another example, and as shown by reference number 715, the network deployment may utilize a dynamic TDM and/or FDM where the resources allocated for the first RAT and the second RAT change over time. Further, as shown by reference number 720, the network deployment may utilize spatial division multiplexing (SDM) to allocate time domain resources and/or frequency domain resources to multiple RATs (e.g., where the first RAT and the second RAT use common time domain resources and frequency domain resources, but different spatial domain resources).

RF constraints and propagation properties that are unique to the high frequency bands may introduce new design challenges for wireless networks. For example, the high frequency bands may be associated with a high path loss. Therefore, to compensate for the high path loss, the network entities may communicate using narrow beams (for example, beams with a narrow beam width or signals with energy concentrated over a narrow directional range). In such examples, SDM may be used (for example, where different, spatially separable antenna beams are formed for different UEs). However, the narrow beams may be susceptible to beam blockage, interference, or other intervening factors that degrade performance of signals communicated via the narrow beams. Therefore, high-band cells may be associated with a smaller coverage area (e.g., a geographic area associated with a cell) as compared to cells using a lower operating frequency (e.g., which may be referred to herein as “low-band cells”). Because of the smaller coverage area of high-band cells, in some network deployments, high-band cells may be more densely distributed in the wireless network as compared to low-band cells. For example, multiple high-band network nodes (e.g., multiple RUs) may be deployed within a coverage area of a single low-band network node (e.g., within a coverage area of a low-band cell).

Additionally, high frequency (e.g., sub-THz) operations may be associated with a decreased efficiency of a power amplifier of the network entities. For example, a power amplifier power may decrease as a function of frequency and as a function of bandwidth. Therefore, high frequency (e.g., sub-THz) operations may be associated with lower power amplifier power and lower power amplifier efficiency. This may result in a reduced effective isotropic radiated power (EIRP) that a device is capable of producing, resulting in the reduced coverage for high-band cells. As another example, high frequency (e.g., sub-THz) operations may be associated with increased power consumption. For example, high frequency (e.g., sub-THz) operations may be associated with a larger bandwidth (e.g., due to a larger subcarrier spacing) and high data rates. The larger bandwidth, coupled with less power efficient RF processing, increased sampling rates (e.g., for an analog-to-digital converter or a digital-to-analog converter), increased digital processing rates, increased bit rates, and/or increased storage or memory requirements, among other examples, may increase power consumption of wireless communication devices using the high frequency bands, such as a sub-THz band.

The poor coverage, increased power consumption, and narrow beams associated with high-band cells and/or high-band spectrums may introduce challenges for the introduction of higher frequency RATs, such as the second RAT. For example, higher frequency cells and/or spectrums may be associated with improved throughput and/or availability, but may suffer from high propagation loss, reduced reliability, and/or reduced coverage, among other examples. Lower frequency cells and/or spectrums may be associated with improved reliability and/or coverage, but may be associated with reduced throughput and/or availability (e.g., as compared to higher frequency cells and/or spectrums). Therefore, it is beneficial to have a low-band and/or mid-band spectrum (such as the shared spectrum 615) available for higher frequency RATs, such as the second RAT (e.g., for the improved availability, improved reliability, and/or improved coverage associated with the low-band and/or mid-band spectrum).

In some cases, a network entity (e.g., that is configured to operate using a high frequency RAT, such as the second RAT described above) may receive control information (e.g., scheduling information and/or scheduling grants, such as downlink control information (DCI)) via a shared spectrum, such as the shared spectrum 615 (e.g., to improve the coverage and/or reliability of the control information). For example, using a shared spectrum associated with a low-band or mid-band spectrum may improve the coverage and/or reliability of control information transmissions associated with the high frequency RAT (e.g., as compared to transmissions of the control information using a higher frequency spectrum). However, network resources and/or bandwidth within the shared spectrum may be limited. For example, because the shared spectrum may be used for other RATs and/or other types of signaling (such as SSB transmissions, uplink control channel feedback transmissions, and/or paging transmissions), an availability of resources in the shared spectrum may be limited. Additionally, a size of the control signaling (e.g., a size of DCI) for the high frequency RAT may be large. For example, DCI for the high frequency RAT may indicate additional information (e.g., associated with features supported by the high frequency RAT that may not be supported by other RATs) resulting in a larger size (e.g., a larger payload size) of the DCI. As a result, control information that is transmitted via a shared spectrum may experience increased latency due to the limited availability of network resources in the shared spectrum. Alternatively, control information that is transmitted via a higher frequency spectrum may be associated with reduced coverage and/or reliability.

As indicated above, FIG. 7 is provided as an example. Other examples may differ from what is described with regard to FIG. 7.

FIG. 8 is a diagram of an example associated with operations 800 associated with a multi-stage grant for multi-RAT spectrum sharing, in accordance with the present disclosure. As shown in FIG. 8, a first network entity 805 may communicate with a second network entity 810. In some aspects, the first network entity 805 and the second network entity 810 may be part of a wireless network (for example, the wireless network 300). The first network entity 805 and the second network entity 810 may be the network entity 102, the network entity 104, the network entity 106, the apparatus 200, the network node 310, the UE 320, a base station, a CU, a DU, and/or an RU, among other examples. In some aspects, the first network entity 805 may be a base station, a CU, a DU, and/or an RU (e.g., a network node 310) and the second network entity 810 may be a UE (e.g., a UE 320).

In some aspects, the first network entity 805 may be associated with a wireless network that supports a first RAT and a second RAT. The second RAT may be a RAT subsequent to the first RAT (e.g., the first RAT may be a “legacy” RAT and the second RAT may be a “new” RAT). In some examples, a frequency range allocated for the second RAT may include at least a portion of a frequency range allocated for the first RAT and one or more additional frequency domain resources outside of the frequency range allocated for the first RAT. The one or more additional frequency domain resources outside of the frequency range allocated for the first RAT may be associated with a higher frequency than the frequency range allocated for the first RAT. For example, the first RAT may be a 5G RAT or an NR RAT and the second RAT may be a 6G RAT. As another example, the first RAT may be a 4G RAT and the second RAT may be the 6G RAT. As another example, the first RAT may be the 6G RAT and the second RAT may be a RAT subsequent to 6G (e.g., a 7G RAT). In some aspects, the second network entity 810 may be capable of communicating via the second RAT (e.g., when operating in the wireless network).

As shown by reference number 815, the second network entity 810 may transmit, and the first network entity 805 may receive, a capability report. The second network entity 810 may transmit the capability report via capability signaling, a UE assistance information (UAI) communication, an RRC communication, a physical uplink shared channel (PUSCH), and/or a physical uplink control channel (PUCCH), among other examples. In some aspects, the second network entity 810 may transmit the capability report via a shared spectrum (e.g., a spectrum or frequency band shared with both the first RAT and the second RAT). As another example, the second network entity 810 may transmit the capability report via a frequency associated with the second RAT. As another example, the second network entity 810 may transmit the capability report via a frequency associated with the first RAT.

The capability report may indicate support for one or more operations described herein. For example, the capability report may indicate whether the second network entity 810 supports one or more operations described herein. For example, the capability report may indicate whether the second network entity 810 supports a multi-stage grant for uplink and/or downlink scheduling, as described in more detail elsewhere herein. In some aspects, the capability report may indicate whether the second network entity 810 supports communicating via a shared spectrum (e.g., a multi-RAT shared spectrum), in a similar manner as described in connection with FIG. 6. In some aspects, the capability report may indicate one or more supported parameters associated with the multi-stage grant described herein, such as one or more supported code rates, and/or one or more support aggregation levels, among other examples. In some aspects, the capability report may indicate whether the second network entity 810 supports receiving the multi-stage grant via a multiplexed communication, as described in more detail elsewhere herein.

The first network entity 805 may configure the second network entity 810 in accordance with the capability report. For example, the first network entity 805 may configure, or may trigger, the second network entity 810 to perform one or more operations based on, in response to, or otherwise associated with the capability report indicating that the second network entity 810 supports the one or more operations. As an example, the first network entity 805 may configure, or may trigger, the second network entity 810 to monitor for and/or receive control information via a multi-stage grant based on, in response to, or otherwise associated with the capability report indicating that the second network entity 810 supports the multi-stage grant.

As shown by reference number 820, the first network entity 805 may transmit, and the second network entity 810 may receive, configuration information. In some aspects, the first network entity 805 may transmit the configuration information via one or more of system information signaling, RRC signaling, one or more MAC control elements (MAC-CEs), and/or DCI, among other examples. In some aspects, the configuration information may include an indication of one or more configuration parameters for selection by the second network entity 810, and/or explicit configuration information for the second network entity 810 to use to configure itself, among other examples. The first network entity 805 may transmit the configuration information via the shared spectrum or via a carrier frequency associated with the first RAT.

The configuration information may indicate that the second network entity 810 is to receive scheduling information (e.g., scheduling grants) via a multi-stage grant, as described in more detail elsewhere herein. As used herein, “multi-stage grant” may refer to a grant (e.g., a scheduling grant and/or DCI) that is transmitted via two or more messages. Some examples herein describe the multi-stage grant as including two messages. However, the multi-stage grant may include more than two messages in a similar manner as described herein. The multi-stage grant may include a first message that includes information associated with detecting and/or decoding a second message of the multi-stage grant. The second message may indicate information associated with detecting and/or decoding a communication (e.g., a communication scheduled by the multi-stage grant). The first message and the second message may be transmitted via different carrier frequencies (e.g., via different operating frequencies, different frequency bands, and/or different carriers). For example, the first message may be transmitted via a shared spectrum (e.g., for improved reliability and/or improved coverage) and the second message may be transmitted via a spectrum associated with the second RAT (e.g., for improved availability of network resources and/or improved throughput). The communication scheduled by a multi-stage grant may be associated with the second RAT. The communication scheduled by a multi-stage grant may be an uplink communication (e.g., where the multi-stage grant is an uplink grant) or a downlink communication (e.g., where the multi-stage grant is a downlink grant). The communication scheduled by the multi-stage grant may include data information, control information, and/or one or more reference signals to be transmitted via an uplink channel or a downlink channel (e.g., using the second RAT).

In some aspects, the configuration information may indicate values for one or more parameters associated with the multi-stage grant. The one or more parameters may include a modulation order, an MCS, a size, a coding rate (or code rate), and/or an aggregation level, among other examples. The one or more parameters may be associated with a first message of the multi-stage grant (e.g., that is to be transmitted via the shared spectrum). Additionally, or alternatively, one or more parameters of the first message may be defined, or otherwise fixed, by a wireless communication standard, such as the 3GPP (e.g., referred to herein as “fixed parameters”).

In some aspects, the configuration information may indicate a range of allowable values for one or more parameters associated with the first message of the multi-stage grant. For example, the configuration information may indicate a value of a parameter that is within a limited range of values (e.g., for a modulation order, an MCS, a size, a coding rate (or code rate), and/or an aggregation level). The range of values may be indicated by system information signaling, RRC signaling, and/or may be defined, or otherwise fixed, by a wireless communication standard, such as the 3GPP. The configuration information may indicate a value that is included in the range of values associated with a given parameter. In other words, the configuration information may include information indicative of a respective range of values for each parameter of one or more parameters associated with the multi-stage grant (e.g., associated with the first message of the multi-stage grant). The second network entity 810 may be configured with a value of one or more of the parameters in accordance with the range of values.

In some aspects, the configuration information may indicate an identification number associated with the multi-stage grant (e.g., associated with the first message of the multi-stage grant). The identification number may be a radio network temporary identifier (RNTI). For example, the configuration information may indicate that the first message is to be scrambled using the identification number (e.g., using the RNTI). The RNTI may be a UE-specific RNTI (e.g., specific to the second network entity 810), a group RNTI (e.g., associated with a group of network entities including the second network entity 810), and/or a fixed RNTI (such as a system information (SI)-RNTI), among other examples.

In some aspects, the configuration information may indicate whether one or more (or all) messages of the multi-stage grant are to be transmitted via multiplexed communications. As used herein, “multiplexed” or “multiplexing” may refer to two or more signals that are combined or aggregated into one signal over a shared medium (e.g., over a shared channel). For example, the configuration information may indicate that the first message of the multi-stage grant is to be multiplexed. For example, the configuration information may indicate that the first message of the multi-stage grant is to be multiplexed with an SSB transmission, a physical downlink shared channel (PDSCH) transmission, or a physical downlink control channel (PDCCH) transmission, among other examples. Multiplexing the first message of the multi-stage grant with one or more other signals may conserve network resources that would have otherwise been used to separately transmit the first message and the one or more other signals.

In some aspects, the configuration information may include a search space configuration and/or a control resource set (CORESET) configuration. For example, the second network entity 810 may receive a configuration of a search space (e.g., associated with a reception of one or more messages of the multi-stage grant, such as the first message). The potential control region of a slot may be referred to as a CORESET and may be structured to support an efficient use of resources, such as by flexible configuration or reconfiguration of resources of the CORESET for one or more PDCCHs and/or one or more PDSCHs. In some aspects, the CORESET may occupy the first symbol of a slot, the first two symbols of a slot, or the first three symbols of a slot, among other examples. Thus, a CORESET may include multiple resource blocks (RBs) in the frequency domain, and either one, two, or three symbols in the time domain. A symbol that includes a CORESET may include one or more control channel elements (CCEs) that span a portion of the system bandwidth. A CCE may include DCI that is used to provide control information for wireless communication. For example, the first network entity 805 may transmit one or more messages of the multi-stage grant (such as the first message) during one or more CCEs of a CORESET, where the quantity of CCEs used for transmission of the one or more messages represents the aggregation level (AL) used by the first network entity 805 for the transmission of the one or more messages. In some aspects, different aggregation levels may be used, such as 1, 2, 4, 8, 16, or another aggregation level.

Each CCE may include a fixed quantity of resource element groups (REGs), such as 6 REGs, or may include a variable quantity of REGs. In some aspects, the quantity of REGs included in a CCE may be specified by a REG bundle size. A REG may include one resource block, which may include 12 resource elements (REs) within a symbol. A resource element may occupy one subcarrier in the frequency domain and one OFDM symbol in the time domain. A search space may include all possible locations (e.g., in time and/or frequency) where a PDCCH may be located. A CORESET may include one or more search spaces, such as a UE-specific search space, a group-common search space, and/or a common search space, among other examples. A search space may indicate a set of CCE locations where the second network entity 810 may find PDCCHs that can potentially be used to transmit control information to the second network entity 810. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all network entities (e.g., all UEs in a cell or wireless network) may be referred to as a common search space. The set of all possible PDCCH locations for a particular group of network entities may be referred to as a group-common search space. One or more search spaces across aggregation levels may be referred to as a search space (SS) set.

For example, the configuration information may indicate a search space in which one or more messages of the multi-stage grant are to be transmitted. In some aspects, the configuration information may indicate a search space in which the first message of the multi-stage grant is to be transmitted. The search space may be a common search space, a UE-specific search space, or another type of search space.

The second network entity 810 may configure itself in accordance with the configuration information. For example, the second network entity 810 may be configured to perform one or more operations described herein based on, in accordance with, or otherwise associated with the configuration information.

As shown by reference number 825, the first network entity 805 may transmit, and the second network entity 810 may receive, a first message of a multi-stage grant. The multi-stage grant may schedule a communication. The multi-stage grant may include at least the first message and a second message (e.g., in some cases, the multi-stage grant may include more than two messages). The first message may be referred to as an MSG-1 or an initial message and the second message may be referred to as an MSG-2. The first network entity 805 may determine or detect that the second network entity 810 is to transmit or receive the communication. Therefore, the first network entity 805 may transmit the multi-stage grant to schedule the communication for the second network entity 810.

The first network entity 805 may transmit, and the second network entity 810 may receive, the first message via a first frequency carrier (e.g., via a first operating frequency, a first carrier frequency, a first frequency band, and/or a first frequency spectrum). The first frequency carrier may be associated with the first RAT (e.g., a legacy RAT, a lower frequency RAT, a 4G RAT, or a 5G RAT). Additionally, the first frequency carrier may be associated with the second RAT (e.g., a new RAT, a higher frequency RAT, a 6G RAT, or a 7G RAT). For example, the first frequency carrier may be associated with (e.g., may be included in) a shared spectrum. For example, a multi-RAT shared spectrum may include the first frequency carrier (e.g., may include a frequency or frequency band associated with the first frequency carrier). The first network entity 805 may transmit communications via the multi-RAT shared spectrum using both the first RAT and the second RAT, as described in more detail elsewhere herein.

The first message may include or otherwise indicate first information. The first information may be partial scheduling information (e.g., may be less information than is typically included in DCI associated with scheduling a downlink communication or an uplink communication). The first information may be associated with a next message (e.g., next in time) included in the multi-stage grant. For example, the first information may be associated with the second message included in the multi-stage grant.

In some aspects, the first information may include scheduling information associated with the second message. For example, the first information may indicate a first resource allocation for the second message (e.g., a time domain resource allocation, a frequency domain resource allocation, a spatial domain resource allocation, and/or a code domain resource allocation). In other words, the first information may include or otherwise indicate a radio resource allocation of the second message. The first information may indicate a frequency carrier (e.g., a second frequency carrier) that is associated (e.g., that is to be used to transmit) the second message. For example, the first information may include a carrier indication for the second message.

In some aspects, the first information may include or otherwise indicate a size of the second message (e.g., a payload size of the second message). The first information may include or otherwise indicate modulation and/or coding information for the second message. For example, the first information may indicate an MCS, a modulation order, a coding scheme, and/or a code rate (e.g., coding rate), among other examples, of the second message (e.g., that is to be used to transmit the second message).

For example, the first information may include or otherwise indicate a first one or more communication parameters associated with the second message. The first one or more communication parameters may include the radio resource allocation, a priority level (e.g., a quality of service (QoS) priority level, an address resolution protocol (ARP) priority level, or another priority level), the carrier indication (or carrier indicator), the payload size, the MCS, the code rate, a DMRS configuration (e.g., an indication of a DMRS port index), and/or a cyclic redundancy check (CRC) configuration, among other examples. The CRC configuration may indicate a size associated with a CRC to be associated with the second message (e.g., 2 bytes, 3 bytes, or another size). The one or more communication parameters may facilitate the detection, decoding, and/or reception of the second message.

For example, the first information may include information associated with identifying, detecting, decoding, and/or otherwise receiving the second message. By transmitting the first message via the first frequency carrier included in the multi-RAT shared spectrum, a coverage and/or reliability of the first message may be improved. By including information to facilitate the identification, detection, decoding, and/or reception of the second message in the first message (e.g., the first information), a reliability associated with the second message may be improved (e.g., where the second message is transmitted via a higher frequency than is typically associated with reduced reliability as compared to the multi-RAT shared spectrum). For example, the first message may be transmitted via a lower frequency for improved coverage and/or reliability and the second message may be transmitted via a higher frequency for improved throughput. The first message may include the first information, which may improve the reliability of the second message and may be associated with a smaller size than typical scheduling information. For example, the first information may be associated with a smaller size (e.g., a smaller payload size) than if the first message were to include information to schedule the communication (e.g., that is scheduled by the multi-stage grant). Reducing the size of the first message conserves network resources in the multi-RAT shared spectrum (e.g., that may be limited because the network resources in the multi-RAT shared spectrum are shared among multiple RATs and/or multiple services).

In some aspects, the first information may include or otherwise indicate information associated with the communication that is scheduled by the multi-stage grant. For example, the first information may indicate a type of communication scheduled by the multi-stage grant (e.g., downlink or uplink). For example, the first information may indicate a format associated with the multi-stage grant. The format may be a DCI format or another format. The format may be indicative of the type of communication scheduled by the multi-stage grant. For example, the format may be a downlink format or an uplink format (e.g., where a downlink format is associated with scheduling downlink communications and an uplink format is associated with scheduling uplink communications).

In some aspects, the first information may include information associated with future first messages (e.g., MSG-1s) of multi-stage grants. For example, the first information may include a monitoring adaptation parameter. The monitoring adaptation parameter may indicate a modification to a monitoring pattern associated with the first messages. For example, as described elsewhere herein, the second network entity 810 may monitor time/frequency occasions for first messages (e.g., MSG-1s) of multi-stage grants (e.g., where an occasion is a time/frequency resource in which a first message may be transmitted by the first network node 805). For example, the second network entity 810 may monitor a CORESET and/or a search space configured for first messages (e.g., MSG-1s) of multi-stage grants. The monitoring adaptation parameter may indicate a modification to the monitoring of the time/frequency occasions (e.g., of the CORESET and/or the search space). For example, the monitoring adaptation parameter may indicate that the second network entity 810 is to skip the monitoring of one or more configured time/frequency occasions. This may enable the second network entity 810 to conserve processing resources and/or power resources that would have otherwise been used to monitor the one or more configured time/frequency occasions (e.g., where the first network entity 805 knows that no transmissions will be transmitted via the one or more configured time/frequency occasions).

The first network entity 805 may transmit, and the second network entity 810 may receive, the first message via a multi-RAT shared spectrum carrier. For example, the first network entity 805 may transmit, and the second network entity 810 may receive, the first message via a downlink time interval (e.g., one or more downlink slots, one or more downlink symbols, one or more downlink mini-slots, or one or more other downlink time intervals). As another example, the first network entity 805 may transmit, and the second network entity 810 may receive, the first message via flexible time intervals (e.g., one or more flexible slots, one or more flexible symbols, one or more flexible mini-slots, or one or more other flexible time intervals). A flexible time interval may be a time interval that can be dynamically changed between, or configured for, either downlink communications or uplink communications. For example, the first network entity 805 may transmit, and the second network entity 810 may receive, the first message via a downlink time interval or a flexible time interval of a multi-RAT shared spectrum carrier. The time interval (e.g., the downlink time interval or the flexible time interval) may be a frequency-division-duplexing (FDD) time interval (e.g., a time interval during which FDD is used) or a time-division-duplexing (TDD) time interval (e.g., a time interval during which TDD is used). Additionally, or alternatively, the time interval may be a full-duplex time interval during which the first network entity 805 and/or the second network entity 810 operate in a full-duplex mode. The full-duplex time interval may include a subband-full-duplex time interval (e.g., a time interval during which subband-full-duplex operations are performed) or an in-band-full-duplex time interval (e.g., a time interval during which in-band-full-duplex operations are performed).

As shown by reference number 830, the second network entity 810 may perform a blind decoding operation to detect and/or decode the first message. For example, the second network entity 810 may decode the first message via a blind decoding operation. “Blind decoding” may refer to a decoding operation in which an entity (e.g., the second network entity 810) performs decoding with knowledge of a set of one or more radio resources in which a communication (e.g., the first message) may be transmitted, but not the specific location of the communication within the set of one or more radio resources.

For example, the first network entity 805 may transmit, and the second network entity 810 may receive, the first message via a configured search space and/or CORESET. The second network entity 810 may monitor the search space and/or CORESET. The second network entity 810 may detect and/or decode the first message based on monitoring the search space and/or CORESET. As described elsewhere herein, the search space may be a UE-specific search space or a common search space (e.g., configured via the configuration information, system information signaling, and/or RRC signaling).

The first message may be associated with one or more fixed parameters and/or one or more parameters with respective values indicated by the configuration information. This reduces a complexity associated with the blind decoding operation because the second network entity 810 may know the value(s) of the parameter(s) of the first message and may not have to attempt to decode the first message using multiple candidate values of the parameter(s). The one or more fixed parameters may include a modulation order, an MCS, a size, a code rate (e.g., a coding rate), a CRC length or size, and/or an aggregation level, among other examples. For example, the first message may have a fixed modulation order. In some aspects, a payload size of the first message may be fixed. In other aspects, the payload size of the first message may be configured (e.g., via the configuration information) within a limited range (e.g., where the limited range is indicated via system information signaling or RRC signaling).

In some aspects, the code rate (e.g., coding rate) and/or the aggregation level of the first message may be configured (e.g., via the configuration information) within a limited range (e.g., where the limited range is indicated via system information signaling or RRC signaling). In some aspects, the first message may include a CRC. The length or size of the CRC may be fixed (e.g., by a wireless communication standard, such as the 3GPP). In some aspects, the first message may be scrambled via an RNTI, such as a UE specific RNTI, a group RNTI, and/or a fixed RNTI (e.g., an SI-RNTI), among other examples. For example, the CRC included in the first message may be scrambled by the RNTI.

In some aspects, the first message may be multiplexed with a downlink control channel and/or a downlink data channel associated with the first RAT. For example, the first network entity 805 may transmit, and the second network entity 810 may receive, the first message via at least one transmission associated with the first RAT. The at least one transmission may include an SSB transmission, a PDCCH transmission, and/or a PDSCH transmission. The first message may be multiplexed in the at least one transmission. In other words, the first network entity 805 may transmit, and the second network entity 810 may receive, multiplexed information. The multiplexed information may include the first message. Additionally, the multiplexed information may include an SSB transmission, a PDCCH transmission, and/or a PDSCH transmission. For example, the first message may be multiplexed with downlink data and/or control channels of the first RAT, including SSB, PDCCH, and/or PDSCH, among other examples. This may conserve network resources that would have otherwise been used to separately transmit multiple communications (including the first message) that are included in a multiplexed communication via the multi-RAT shared spectrum.

As shown by reference number 835, the first network entity 805 may transmit, and the second network entity 810 may receive, the second message of the multi-stage grant. The first network entity 805 may transmit, and the second network entity 810 may receive, the second message after receiving the first message (e.g., after in time). The first network entity 805 may transmit, and the second network entity 810 may receive, the second message via a second frequency carrier (e.g., via a second operating frequency, a second carrier frequency, a second frequency band, and/or a second frequency spectrum). The second frequency carrier may be associated with the second RAT (e.g., a new RAT, a higher frequency RAT, a 6G RAT, or a 7G RAT).

The second frequency carrier may be associated with a first frequency range that is equal to or greater than a second frequency range associated with the first frequency carrier. In other words, the first network entity 805 may transmit, and the second network entity 810 may receive, the second message using a higher frequency than a frequency used to communicate the first message. This may improve a throughput of the second message (e.g., as compared to the first message). The first network entity 805 may transmit, and the second network entity 810 may receive, the second message using a downlink time interval or a flexible time interval associated with the second frequency carrier and/or the second RAT.

In some aspects, the first message and the second message may be associated with the same channel coding scheme (e.g., a same MCS). This may reduce a complexity and/or signaling overhead associated with the multi-stage grant (e.g., because the channel coding scheme for the second message may not need to be separately indicated). In other aspects, the first message may be associated with a first channel coding scheme and the second message may be associated with a second channel coding scheme. This may increase flexibility for the network (e.g., the first network entity 805) to adjust the channel coding scheme based on channel conditions for the different carriers associated with the first message and the second message, which may improve the performance of the second message and/or the first message.

The second message may indicate second information. The second information may be associated with the communication (e.g., that is scheduled by the multi-stage grant). In some aspects, the second information may indicate scheduling information for the communication. For example, the second information may indicate a resource allocation for the communication (e.g., a time domain resource allocation, a frequency domain resource allocation, a spatial domain resource allocation, and/or a code domain resource allocation). In other words, the first information may include or otherwise indicate a radio resource allocation for the communication.

For example, the second information may indicate a second one or more communication parameters associated with the communication. The second one or more communication parameters may include a third frequency carrier (e.g., a frequency carrier to be used for the communication), a bandwidth part (BWP) indicator (e.g., the second information may indicate a BWP associated with the communication), a scheduling offset parameter, the radio resource allocation, coverage enhancement information, precoding information, antenna port information, an MCS, a new data indicator (NDI), hybrid automatic repeat request (HARQ) information (e.g., a HARQ-acknowledgement (HARQ-ACK) codebook indication), a redundancy version parameter, a HARQ process identifier or HARQ process number, a downlink assignment indicator or a downlink assignment index, power control information, and/or reference signal resource information, among other examples.

The coverage enhancement information may include or otherwise indicate a transport block (TB) scaling parameter, a frequency hopping parameter, a repetition parameter (e.g., indicating whether repetitions are enabled and/or a quantity of repetitions), and/or a TB over multiple slots (TBoMS) parameter (e.g., indicating whether TBoMS is enabled for the communication), among other examples. The power control information may include or otherwise indicate uplink power control information, open loop power control information, closed loop power control information, a maximum transmit power, a target reception power, a pathloss for an uplink BWP, a p0 parameter, and/or an alpha parameter for the BWP, among other examples. The reference signal resource information may include or otherwise indicate one or more reference signal requests (e.g., requests for the second network entity 810 to transmit one or more reference signals), one or more reference signal resource indicators, one or more sequence configurations, and/or one or more reference signal associations (e.g., an association between a first reference signal and a second reference signal, such as an association between a phase tracking reference signal (PTRS) and a DMRS), among other examples.

In some aspects, the second information may include information for one or more parameters that are associated with the second RAT. For example, the one or more parameters that are associated with the second RAT may be associated with features and/or services introduced and/or supported by the second RAT (e.g., that may not be supported by the first RAT). For example, the one or more parameters that are associated with the second RAT may include a BWP indicator, the coverage enhancement information, and/or another parameter that is specific to the second RAT.

As shown by reference number 840, the second network entity 810 may detect and/or decode the second message based on, in response to, or otherwise associated with, the first information indicated by the first message of the multi-stage grant. For example, the second network entity 810 may decode the second message based on the first information.

For example, to receive the second message, the second network entity 810 may receive the second message via the first resource allocation that is indicated by the first information (e.g., included in or otherwise indicated by the first message). Additionally, to receive the second message, the second network entity 810 may receive the second message based on the first one or more communication parameters that are indicated by the first information (e.g., included in or otherwise indicated by the first message).

In some aspects, the second network entity 810 may monitor the resource allocation indicated by the first information to detect the second message. The second network entity 810 may decode the second message (e.g., to obtain the second information) using the first one or more communication parameters that are indicated by the first information. This may improve a reliability and/or decrease a decoding complexity associated with receiving and/or decoding the second message because the second network entity 810 may decode the second message using the indicated parameters (e.g., a blind decoding operation may not be performed to decode the second message).

As shown by reference number 845, the second network entity 810 may communicate (e.g., transmit or receive) the communication that is scheduled by the multi-stage grant. For example, if the communication is an uplink communication, then the second network entity 810 may transmit, and the first network entity 805 (or another network entity) may receive, the communication via an uplink channel (e.g., a physical uplink shared channel (PUSCH) or a physical uplink control channel (PUCCH)). Alternatively, if the communication is a downlink communication, then the first network entity 805 (or another network entity) may transmit, and the second network entity 810 may receive, the communication via a downlink channel (e.g., a PDSCH or a PDCCH). As described elsewhere herein, the communication may be an uplink communication, a downlink communication, a data communication (e.g., including data information), a control communication (e.g., including control information), and/or a reference signal communication, among other examples. In some aspects, the communication may be a combination of multiple communications (e.g., a multiplexed communication).

The second network entity 810 may communicate the communication based on information indicated by the multi-stage grant. The second network entity 810 may communicate the communication based on the second information. In some aspects, the second network entity 810 may communicate the communication based on the first information and the second information. For example, to communicate the communication, the second network entity 810 may transmit or receive the communication via the second resource allocation indicated by the second information (e.g., that is included in or otherwise indicated by the second message). Additionally, to communicate the communication, the second network entity 810 may transmit or receive the communication based on (or using) the second one or more communication parameters indicated by the second information (e.g., that is included in or otherwise indicated by the second message).

The communication may be transmitted or received via a third frequency carrier. The third frequency carrier may be equal to or greater than the second frequency carrier (e.g., that is associated with the second message). In other aspects, the third frequency carrier may be less than the second frequency carrier. The communication may be associated with the second RAT. For example, the communication may use a format and/or parameters that are associated with the second RAT. Additionally, the third frequency carrier may be associated with the second RAT (e.g., may be included in a frequency band or a frequency range that is associated with or allocated for the second RAT).

As indicated above, FIG. 8 is provided as an example. Other examples may differ from what is described with respect to FIG. 8.

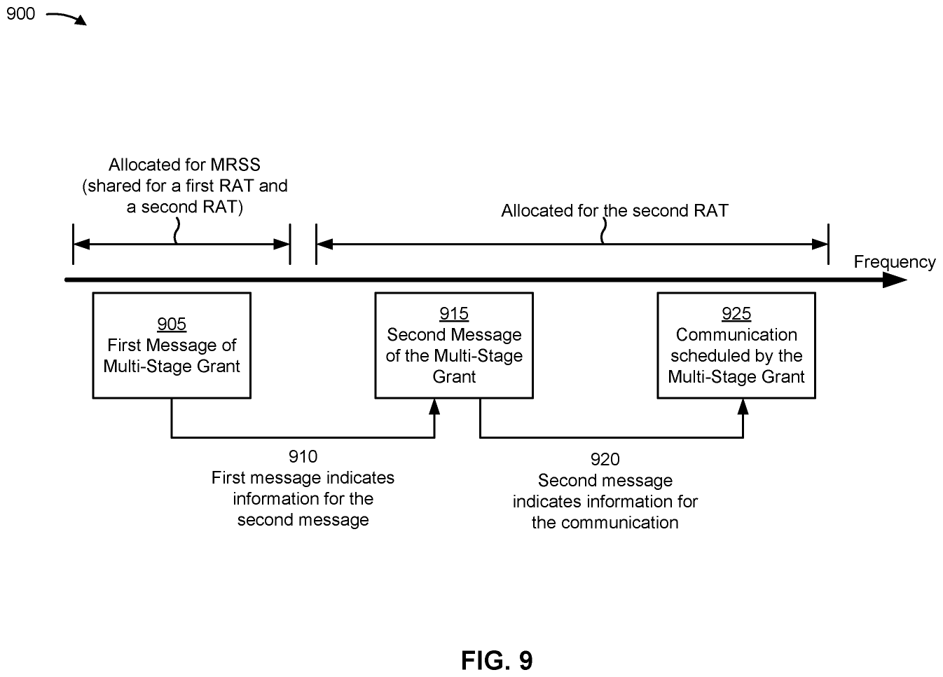

FIG. 9 is a diagram of an example 900 associated with a multi-stage grant for multi-RAT spectrum sharing, in accordance with the present disclosure.

As shown in FIG. 9, the multi-stage grant may include a first message 905. The first message 905 may be similar to the first message described elsewhere herein, such as in connection with FIG. 8 and reference number 825. The first message 905 may be transmitted via a frequency (e.g., a frequency carrier) that is included in a multi-RAT shared spectrum (e.g., a frequency range or frequency band that is shared between a first RAT and a second RAT, as described elsewhere herein). As shown by reference number 910, the first message 905 may include or otherwise indicate information for a second message 915 of the multi-stage grant.

For example, the first message 905 may include information to facilitate the detection and/or decoding of the second message 915. A network entity may perform blind decoding to receive and/or decode the first message 905. The network entity may use information obtained from the first message 905 to receive and/or decode the second message 915. For example, the multi-RAT shared spectrum may be associated with a relatively lower frequency range that is associated with improved coverage and/or reliability as compared to frequency ranges otherwise associated with the second RAT. This improves a likelihood that the network entity is able to detect, decode, and/or otherwise receive the first message 905. The second message 915 may be transmitted via a relatively higher frequency range (e.g., associated with the second RAT) for improved throughput and/or improved availability of network resources. Because the network entity obtains the information from the first message 905 for facilitating the detection and/or decoding of the second message 915, a likelihood that the network entity is able to detect, decode, and/or otherwise receive the second message 915 is improved.

As shown by reference number 920, the second message 915 may include information for a communication 925 scheduled by the multi-stage grant, as described in more detail elsewhere herein, such as in connection with FIG. 8 and reference number 835. For example, the second message 915 may include scheduling information and/or DCI associated with the communication. The multi-stage grant may schedule the communicated 925 to be transmitted or received by the network entity.

The second message 915 may be transmitted via a frequency that is equal to or greater than a frequency used to transmit the first message 905. As shown in FIG. 9, the second message 915 and the communication 925 may be associated with frequencies that are associated with or allocated for the second RAT. Although the communication 925 is shown as being associated with a higher frequency that a frequency of the second message 915, the frequency of the communication 925 may be the same as, less than, or greater than the frequency of the second message 915.

As indicated above, FIG. 9 is provided as an example. Other examples may differ from what is described with respect to FIG. 9.

FIG. 10 is a diagram illustrating an example process 1000 performed, for example, by a network entity, in accordance with the present disclosure. Example process 1000 is an example where the network entity (e.g., the second network entity 810, the network entity 102, the network entity 104, the network entity 106, the apparatus 200, a UE 320, or another entity described herein) performs operations associated with multi-stage grant for multi-RAT spectrum sharing.

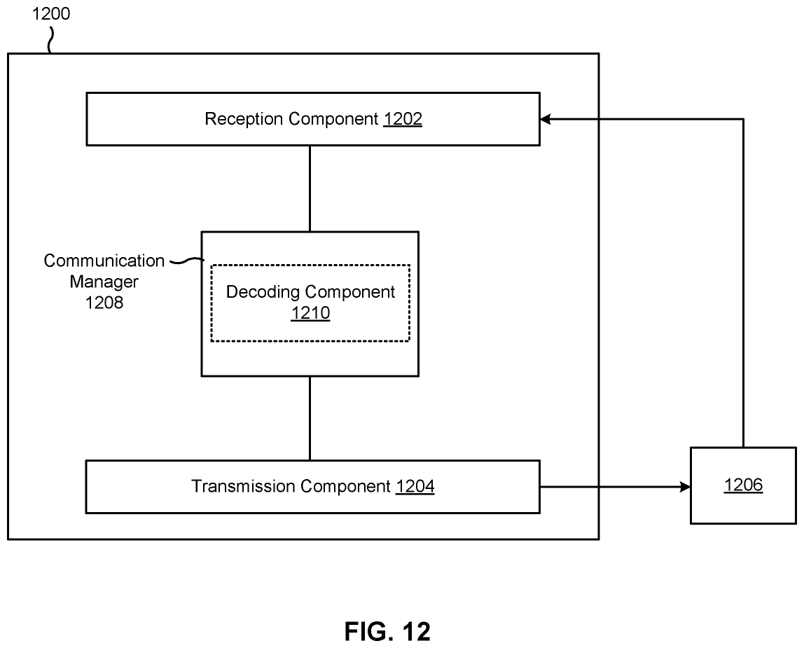

As shown in FIG. 10, in some aspects, process 1000 may include receiving, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT (block 1010). For example, the network entity (e.g., using communication manager 1208 and/or reception component 1202, depicted in FIG. 12) may receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT, as described above.

As further shown in FIG. 10, in some aspects, process 1000 may include receiving, via a second frequency carrier, the second message of the multi-stage grant, wherein the second message indicates second information associated with the communication, and wherein the second frequency carrier is associated with a second RAT (block 1020). For example, the network entity (e.g., using communication manager 1208 and/or reception component 1202, depicted in FIG. 12) may receive, via a second frequency carrier, the second message of the multi-stage grant, wherein the second message indicates second information associated with the communication, and wherein the second frequency carrier is associated with a second RAT, as described above.

As further shown in FIG. 10, in some aspects, process 1000 may include communicating, based on the second information, the communication (block 1030). For example, the network entity (e.g., using communication manager 1208, reception component 1202, and/or transmission component 1204, depicted in FIG. 12) may communicate, based on the second information, the communication, as described above.

Process 1000 may include additional aspects, such as any single aspect or any combination of aspects described below and/or in connection with one or more other processes described elsewhere herein.

In a first aspect, the first frequency carrier is associated with the second RAT.

In a second aspect, alone or in combination with the first aspect, a multi-RAT shared spectrum includes the first frequency carrier.

In a third aspect, alone or in combination with one or more of the first and second aspects, the first information indicates a first resource allocation for the second message, and the second information indicates a second resource allocation for the communication.

In a fourth aspect, alone or in combination with one or more of the first through third aspects, receiving the second message includes receiving via the first resource allocation, the second message, and communicating the communication includes communicating, via the second resource allocation, the communication.

In a fifth aspect, alone or in combination with one or more of the first through fourth aspects, the first information indicates a first one or more communication parameters associated with the second message, and the second information indicates a second one or more communication parameters associated with the communication.

In a sixth aspect, alone or in combination with one or more of the first through fifth aspects, receiving the second message includes receiving the second message based on the first one or more communication parameters, and communicating the communication includes communicating the communication based on the second one or more communication parameters.

In a seventh aspect, alone or in combination with one or more of the first through sixth aspects, the first information indicates at least one of a format associated with the multi-stage grant, the second frequency carrier, a priority level of the second message, a monitoring adaptation parameter, a radio resource allocation of the second message, a size of the second message, a code rate of the second message, a demodulation reference signal configuration of the second message, or a cyclic redundancy check configuration of the second message.

In an eighth aspect, alone or in combination with one or more of the first through seventh aspects, the second information indicates, for the communication, at least one of a third frequency carrier, a bandwidth part, a scheduling offset parameter, a radio resource allocation, coverage enhancement information, precoding information, antenna port information, a modulation and coding scheme, a new data indicator, HARQ information, powering control information, or referencing signal resource information.

In a ninth aspect, alone or in combination with one or more of the first through eighth aspects, the coverage enhancement information indicates at least one of a TB scaling parameter, a frequency hopping parameter, a repetition parameter, or a TB over multiple slots parameter.

In a tenth aspect, alone or in combination with one or more of the first through ninth aspects, process 1000 includes decoding the first message via a blind decoding operation, and decoding the second message based on the first information.

In an eleventh aspect, alone or in combination with one or more of the first through tenth aspects, receiving the first message includes receiving the first message in at least one of a downlink time interval, a flexible time interval, a full-duplex time interval, a subband-full-duplex time interval, a frequency-division-duplexing time interval, or a time-division-duplexing time interval.

In a twelfth aspect, alone or in combination with one or more of the first through eleventh aspects, process 1000 includes receiving a configuration of a search space, and wherein receiving the first message includes receiving the first message via the search space.

In a thirteenth aspect, alone or in combination with one or more of the first through twelfth aspects, the search space is a common search space or a UE specific search space.

In a fourteenth aspect, alone or in combination with one or more of the first through thirteenth aspects, the first message is associated with one or more fixed parameters.

In a fifteenth aspect, alone or in combination with one or more of the first through fourteenth aspects, the one or more fixed parameters include at least one of a modulation order, a size, a coding rate, or an aggregation level.

In a sixteenth aspect, alone or in combination with one or more of the first through fifteenth aspects, process 1000 includes receiving information indicative of a respective range of values for each parameter of one or more parameters associated with the multi-stage grant, wherein the one or more parameters are associated with the first message.

In a seventeenth aspect, alone or in combination with one or more of the first through sixteenth aspects, the one or more parameters include at least one of a size, a coding rate, or an aggregation level.

In an eighteenth aspect, alone or in combination with one or more of the first through seventeenth aspects, the first message is scrambled via an RNTI.

In a nineteenth aspect, alone or in combination with one or more of the first through eighteenth aspects, the RNTI is a UE specific RNTI, a group RNTI, or a fixed RNTI.

In a twentieth aspect, alone or in combination with one or more of the first through nineteenth aspects, receiving the first message includes receiving the first message via at least one transmission associated with the first RAT, wherein the at least one transmission includes an SSB transmission, a PDCCH transmission, or a PDSCH transmission.

In a twenty-first aspect, alone or in combination with one or more of the first through twentieth aspects, the first message is multiplexed in the at least one transmission.

In a twenty-second aspect, alone or in combination with one or more of the first through twenty-first aspects, receiving the first message includes receiving multiplexed information, wherein the multiplexed information includes the first message.

In a twenty-third aspect, alone or in combination with one or more of the first through twenty-second aspects, the multiplexed information includes an SSB transmission, a PDCCH transmission, or a PDSCH transmission.

In a twenty-fourth aspect, alone or in combination with one or more of the first through twenty-third aspects, the first message and the second message are associated with a same channel coding scheme.

In a twenty-fifth aspect, alone or in combination with one or more of the first through twenty-fourth aspects, the first message is associated with a first channel coding scheme and the second message is associated with a second channel coding scheme.

In a twenty-sixth aspect, alone or in combination with one or more of the first through twenty-fifth aspects, the second frequency carrier is associated with a first frequency range that is equal to or greater than a second frequency range associated with the first frequency carrier.

In a twenty-seventh aspect, alone or in combination with one or more of the first through twenty-sixth aspects, communicating the communication includes transmitting, via an uplink data channel, the communication.

In a twenty-eighth aspect, alone or in combination with one or more of the first through twenty-seventh aspects, communicating the communication includes receiving, via a downlink data channel, the communication.

In a twenty-ninth aspect, alone or in combination with one or more of the first through twenty-eighth aspects, receiving the second message includes receiving the second message after receiving the first message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first network entity, in accordance with the present disclosure. Example process 1100 is an example where the first network entity (e.g., the first network entity 805, the network entity 102, the network entity 104, the network entity 106, the apparatus 200, a network node 310, a CU, a DU, an RU, and/or another entity described herein) performs operations associated with a multi-stage grant for multi-RAT spectrum sharing.

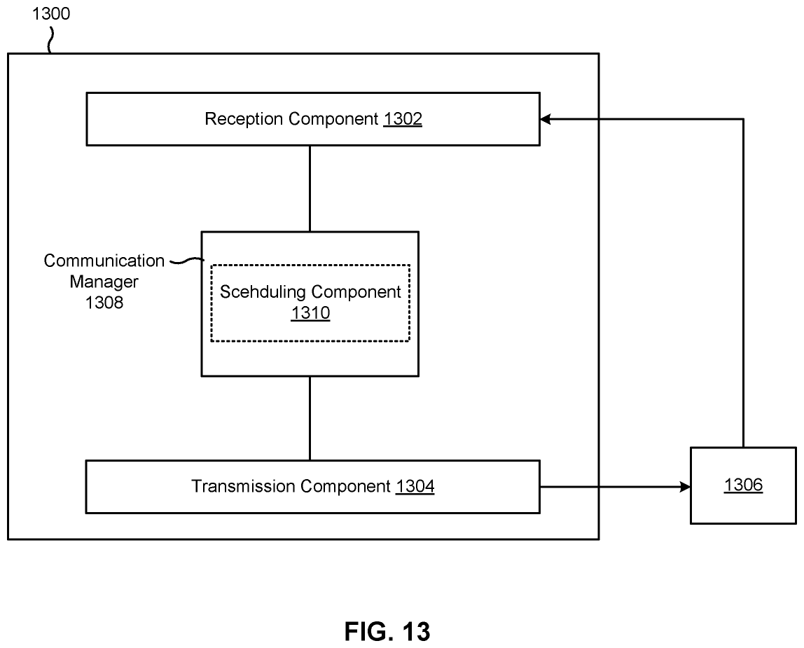

As shown in FIG. 11, in some aspects, process 1100 may include transmitting, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT (block 1110). For example, the first network entity (e.g., using communication manager 1308 and/or transmission component 1304, depicted in FIG. 13) may transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT, as described above.

As further shown in FIG. 11, in some aspects, process 1100 may include transmitting, via a second frequency carrier, the second message of the multi-stage grant, wherein the second message indicates second information associated with the communication, and wherein the second frequency carrier is associated with a second RAT (block 1120). For example, the first network entity (e.g., using communication manager 1308 and/or transmission component 1304, depicted in FIG. 13) may transmit, via a second frequency carrier, the second message of the multi-stage grant, wherein the second message indicates second information associated with the communication, and wherein the second frequency carrier is associated with a second RAT, as described above.

As further shown in FIG. 11, in some aspects, process 1100 may include communicating, based on at least one of the first information or the second information, the communication (block 1130). For example, the first network entity (e.g., using communication manager 1308, reception component 1302, and/or transmission component 1304, depicted in FIG. 13) may communicate, based on at least one of the first information or the second information, the communication, as described above.

Process 1100 may include additional aspects, such as any single aspect or any combination of aspects described below and/or in connection with one or more other processes described elsewhere herein.

In a first aspect, the first frequency carrier is associated with the second RAT.

In a second aspect, alone or in combination with the first aspect, a multi-RAT shared spectrum includes the first frequency carrier.

In a third aspect, alone or in combination with one or more of the first and second aspects, the first information indicates a first resource allocation for the second message, and the second information indicates a second resource allocation for the communication.

In a fourth aspect, alone or in combination with one or more of the first through third aspects, transmitting the second message includes transmitting, via the first resource allocation, the second message, and communicating the communication includes communicating, via the second resource allocation, the communication.

In a fifth aspect, alone or in combination with one or more of the first through fourth aspects, the first information indicates a first one or more communication parameters associated with the second message, and the second information indicates a second one or more communication parameters associated with the communication.

In a sixth aspect, alone or in combination with one or more of the first through fifth aspects, transmitting the second message includes transmitting the second message based on the first one or more communication parameters, and communicating the communication includes communicating the communication based on the second one or more communication parameters.

In a seventh aspect, alone or in combination with one or more of the first through sixth aspects, the first information indicates at least one of a format associated with the multi-stage grant, the second frequency carrier, a priority level of the second message, a monitoring adaptation parameter, a radio resource allocation of the second message, a size of the second message, a code rate of the second message, a demodulation reference signal configuration of the second message, or a cyclic redundancy check configuration of the second message.

In an eighth aspect, alone or in combination with one or more of the first through seventh aspects, the second information indicates, for the communication, at least one of a third frequency carrier, a bandwidth part, a scheduling offset parameter, a radio resource allocation, coverage enhancement information, precoding information, antenna port information, a modulation and coding scheme, a new data indicator, HARQ information, powering control information, or referencing signal resource information.

In a ninth aspect, alone or in combination with one or more of the first through eighth aspects, the coverage enhancement information indicates at least one of a transport block (TB) scaling parameter, a frequency hopping parameter, a repetition parameter, or a TB over multiple slots parameter.

In a tenth aspect, alone or in combination with one or more of the first through ninth aspects, transmitting the first message includes transmitting the first message in at least one of a downlink time interval, a flexible time interval, a full-duplex time interval, a subband-full-duplex time interval, a frequency-division-duplexing time interval, or a time-division-duplexing time interval.

In an eleventh aspect, alone or in combination with one or more of the first through tenth aspects, process 1100 includes transmitting a configuration of a search space, and transmitting the first message includes transmitting the first message via the search space.

In a twelfth aspect, alone or in combination with one or more of the first through eleventh aspects, the search space is a common search space or a user equipment (UE) specific search space.

In a thirteenth aspect, alone or in combination with one or more of the first through twelfth aspects, the first message is associated with one or more fixed parameters.

In a fourteenth aspect, alone or in combination with one or more of the first through thirteenth aspects, the one or more fixed parameters include at least one of a modulation order, a size, a coding rate, or an aggregation level.

In a fifteenth aspect, alone or in combination with one or more of the first through fourteenth aspects, process 1100 includes transmitting information indicative of a respective range of values for each parameter of one or more parameters associated with the multi-stage grant.

In a sixteenth aspect, alone or in combination with one or more of the first through fifteenth aspects, the one or more parameters include at least one of a size, a coding rate, or an aggregation level.

In a seventeenth aspect, alone or in combination with one or more of the first through sixteenth aspects, the first message is scrambled via a radio network temporary identifier (RNTI).

In an eighteenth aspect, alone or in combination with one or more of the first through seventeenth aspects, the RNTI is a UE specific RNTI, a group RNTI, or a fixed RNTI.

In a nineteenth aspect, alone or in combination with one or more of the first through eighteenth aspects, transmitting the first message includes transmitting the first message via at least one transmission associated with the first RAT, wherein the at least one transmission includes a synchronization signal block (SSB) transmission, a physical downlink control channel (PDCCH) transmission, or a physical downlink shared channel (PDSCH) transmission.

In a twentieth aspect, alone or in combination with one or more of the first through nineteenth aspects, the first message is multiplexed in the at least one transmission.

In a twenty-first aspect, alone or in combination with one or more of the first through twentieth aspects, transmitting the first message includes transmitting multiplexed information, wherein the multiplex information includes the first message.

In a twenty-second aspect, alone or in combination with one or more of the first through twenty-first aspects, the multiplexed information includes an SSB transmission, a PDCCH transmission, or a PDSCH transmission.

In a twenty-third aspect, alone or in combination with one or more of the first through twenty-second aspects, the first message and the second message are associated with a same channel coding scheme.

In a twenty-fourth aspect, alone or in combination with one or more of the first through twenty-third aspects, the first message is associated with a first channel coding scheme and the second message is associated with a second channel coding scheme.

In a twenty-fifth aspect, alone or in combination with one or more of the first through twenty-fourth aspects, the second frequency carrier is associated with a first frequency range that is equal to or greater than a second frequency range associated with the first frequency carrier.

In a twenty-sixth aspect, alone or in combination with one or more of the first through twenty-fifth aspects, communicating the communication includes transmitting, via a downlink data channel, the communication.

In a twenty-seventh aspect, alone or in combination with one or more of the first through twenty-sixth aspects, communicating the communication includes receiving, via an uplink data channel, the communication.

In a twenty-eighth aspect, alone or in combination with one or more of the first through twenty-seventh aspects, transmitting the second message includes transmitting the second message after transmitting the first message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, a CU, a DU, an RU, a network entity, a network node, or another wireless communication device) using the reception component 1202 and the transmission component 1204. As further shown, the apparatus 1200 may include the communication manager 1208. The communication manager 1208 may be, or may be similar to, the communication manager 110, the communication manager 114, the communication manager 235, the communication manager 340, and/or the communication manager 350. The communication manager 1208 may include a decoding component 1210, among other examples.

In some aspects, the apparatus 1200 may be configured to perform one or more operations described herein in connection with FIGS. 8 and 9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network entity described in connection with FIG. 2 and/or FIG. 4. Additionally, or alternatively, one or more components shown in FIG. 12 may be implemented within one or more components described in connection with FIG. 2 and/or FIG. 4. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2 and/or FIG. 4.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2 and/or FIG. 4. In some aspects, the transmission component 1204 may be co-located with the reception component 1202 in a transceiver.

The reception component 1202 may receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first RAT. The reception component 1202 may receive, via a second frequency carrier, the second message of the multi-stage grant, wherein the second message indicates second information associated with the communication, and wherein the second frequency carrier is associated with a second RAT. The reception component 1202 or the transmission component 1204 may communicate, based on the second information, the communication.

The decoding component 1210 may decode the first message via a blind decoding operation. The decoding component 1210 may decode the second message based on the first information.

The reception component 1202 may receive a configuration of a search space.

The reception component 1202 may receive information indicative of a respective range of values for each parameter of one or more parameters associated with the multi-stage grant wherein the one or more parameters are associated with the first message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, a CU, a DU, an RU, a network entity, a network node, or another wireless communication device) using the reception component 1302 and the transmission component 1304. As further shown, the apparatus 1300 may include the communication manager 1308. The communication manager 1308 may be, or may be similar to, the communication manager 110, the communication manager 114, the communication manager 235, the communication manager 340, and/or the communication manager 350. The communication manager 1308 may include a scheduling component 1310, among other examples.

In some aspects, the apparatus 1300 may be configured to perform one or more operations described herein in connection with FIGS. 8 and 9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network entity described in connection with FIG. 2 and/or FIG. 4. Additionally, or alternatively, one or more components shown in FIG. 13 may be implemented within one or more components described in connection with FIG. 2 and/or FIG. 4. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2 and/or FIG. 4.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2 and/or FIG. 4. In some aspects, the transmission component 1304 may be co-located with the reception component 1302 in a transceiver.

The transmission component 1304 may transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first RAT. The transmission component 1304 may transmit, via a second frequency carrier, the second message of the multi-stage grant, wherein the second message indicates second information associated with the communication, and wherein the second frequency carrier is associated with a second RAT. The transmission component 1304 or the reception component 1302 may communicate, based on at least one of the first information or the second information, the communication.

The scheduling component 1310 may determine the first information and/or the second information.

The transmission component 1304 may transmit a configuration of a search space.

The transmission component 1304 may transmit information indicative of a respective range of values for each parameter of one or more parameters associated with the multi-stage grant.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a network entity, comprising: receiving, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first radio access technology (RAT); receiving, via a second frequency carrier, the second message of the multi-stage grant, wherein the second message indicates second information associated with the communication, and wherein the second frequency carrier is associated with a second RAT; and communicating, based on the second information, the communication.

Aspect 2: The method of Aspect 1, wherein the first frequency carrier is associated with the second RAT.

Aspect 3: The method of any of Aspects 1-2, wherein a multi-RAT shared spectrum includes the first frequency carrier.

Aspect 4: The method of any of Aspects 1-3, wherein the first information indicates a first resource allocation for the second message, and wherein the second information indicates a second resource allocation for the communication.

Aspect 5: The method of Aspect 4, wherein receiving the second message, comprises: receiving via the first resource allocation, the second message, and wherein communicating the communication comprises: communicating, via the second resource allocation, the communication.

Aspect 6: The method of any of Aspects 1-5, wherein the first information indicates a first one or more communication parameters associated with the second message, and wherein the second information indicates a second one or more communication parameters associated with the communication.

Aspect 7: The method of Aspect 6, wherein receiving the second message, comprises: receiving the second message based on the first one or more communication parameters, and wherein communicating the communication comprises: communicating the communication based on the second one or more communication parameters.

Aspect 8: The method of any of Aspects 1-7, wherein the first information indicates at least one of: a format associated with the multi-stage grant, the second frequency carrier, a priority level of the second message, a monitoring adaptation parameter, a radio resource allocation of the second message, a size of the second message, a code rate of the second message, a demodulation reference signal configuration of the second message, or a cyclic redundancy check configuration of the second message.

Aspect 9: The method of any of Aspects 1-8, wherein the second information indicates, for the communication, at least one of: a third frequency carrier, a bandwidth part, a scheduling offset parameter, a radio resource allocation, coverage enhancement information, precoding information, antenna port information, a modulation and coding scheme, a new data indicator, hybrid automatic repeat request (HARQ) information, power control information, or reference signal resource information.

Aspect 10: The method of Aspect 9, wherein the coverage enhancement information indicates at least one of: a transport block (TB) scaling parameter, a frequency hopping parameter, a repetition parameter, or a TB over multiple slots parameter.

Aspect 11: The method of any of Aspects 1-10, further comprising: decoding the first message via a blind decoding operation; and decoding the second message based on the first information.

Aspect 12: The method of any of Aspects 1-11, wherein receiving the first message comprises: receiving the first message in at least one of: a downlink time interval, a flexible time interval, a full-duplex time interval, a subband-full-duplex time interval, a frequency-division-duplexing time interval, or a time-division-duplexing time interval.

Aspect 13: The method of any of Aspects 1-12, further comprising: receiving a configuration of a search space, and wherein receiving the first message comprises: receiving the first message via the search space. wherein receiving the first message comprises: receiving the first message via the search space.

Aspect 14: The method of Aspect 13, wherein the search space is a common search space or a user equipment (UE) specific search space.

Aspect 15: The method of any of Aspects 1-14, wherein the first message is associated with one or more fixed parameters.

Aspect 16: The method of Aspect 15, wherein the one or more fixed parameters include at least one of: a modulation order, a size, a coding rate, or an aggregation level.

Aspect 17: The method of any of Aspects 1-16, further comprising: receiving information indicative of a respective range of values for each parameter of one or more parameters associated with the multi-stage grant, wherein the one or more parameters are associated with the first message.

Aspect 18: The method of Aspect 17, wherein the one or more parameters include at least one of: a size, a coding rate, or an aggregation level.

Aspect 19: The method of any of Aspects 1-18, wherein the first message is scrambled via a radio network temporary identifier (RNTI).

Aspect 20: The method of Aspect 19, wherein the RNTI is a user equipment (UE) specific RNTI, a group RNTI, or a fixed RNTI.

Aspect 21: The method of any of Aspects 1-20, wherein receiving the first message comprises: receiving the first message via at least one transmission associated with the first RAT, wherein the at least one transmission includes: a synchronization signal block (SSB) transmission, a physical downlink control channel (PDCCH) transmission, or a physical downlink shared channel (PDSCH) transmission.

Aspect 22: The method of Aspect 21, wherein the first message is multiplexed in the at least one transmission.

Aspect 23: The method of any of Aspects 1-22, wherein receiving the first message comprises: receiving multiplexed information, wherein the multiplexed information includes the first message.

Aspect 24: The method of Aspect 23, wherein the multiplexed information includes: a synchronization signal block (SSB) transmission, a physical downlink control channel (PDCCH) transmission, or a physical downlink shared channel (PDSCH) transmission.

Aspect 25: The method of any of Aspects 1-24, wherein the first message and the second message are associated with a same channel coding scheme.

Aspect 26: The method of any of Aspects 1-25, wherein the first message is associated with a first channel coding scheme and the second message is associated with a second channel coding scheme.

Aspect 27: The method of any of Aspects 1-26, wherein the second frequency carrier is associated with a first frequency range that is equal to or greater than a second frequency range associated with the first frequency carrier.

Aspect 28: The method of any of Aspects 1-27, wherein communicating the communication comprises: transmitting, via an uplink data channel, the communication.

Aspect 29: The method of any of Aspects 1-28, wherein communicating the communication comprises: receiving, via a downlink data channel, the communication.

Aspect 30: The method of any of Aspects 1-29, wherein receiving the second message comprises: receiving the second message after receiving the first message.

Aspect 31: A method of wireless communication performed by a first network entity, comprising: transmitting, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first radio access technology (RAT); transmitting, via a second frequency carrier, the second message of the multi-stage grant, wherein the second message indicates second information associated with the communication, and wherein the second frequency carrier is associated with a second RAT; and communicating, based on at least one of the first information or the second information, the communication.

Aspect 32: The method of Aspect 31, wherein the first frequency carrier is associated with the second RAT.

Aspect 33: The method of any of Aspects 31-32, wherein a multi-RAT shared spectrum includes the first frequency carrier.

Aspect 34: The method of any of Aspects 31-33, wherein the first information indicates a first resource allocation for the second message, and wherein the second information indicates a second resource allocation for the communication.

Aspect 35: The method of Aspect 34, wherein transmitting the second message comprises: transmitting, via the first resource allocation, the second message, and wherein communicating the communication comprises: communicating, via the second resource allocation, the communication.

Aspect 36: The method of any of Aspects 31-35, wherein the first information indicates a first one or more communication parameters associated with the second message, and wherein the second information indicates a second one or more communication parameters associated with the communication.

Aspect 37: The method of Aspect 36, wherein transmitting the second message comprises: transmitting the second message based on the first one or more communication parameters, and wherein communicating the communication comprises: communicating the communication based on the second one or more communication parameters.

Aspect 38: The method of any of Aspects 31-37, wherein the first information indicates at least one of: a format associated with the multi-stage grant, the second frequency carrier, a priority level of the second message, a monitoring adaptation parameter, a radio resource allocation of the second message, a size of the second message, a code rate of the second message, a demodulation reference signal configuration of the second message, or a cyclic redundancy check configuration of the second message.

Aspect 39: The method of any of Aspects 31-38, wherein the second information indicates, for the communication, at least one of: a third frequency carrier, a bandwidth part, a scheduling offset parameter, a radio resource allocation, coverage enhancement information, precoding information, antenna port information, a modulation and coding scheme, a new data indicator, hybrid automatic repeat request (HARQ) information, power control information, or reference signal resource information.

Aspect 40: The method of Aspect 39, wherein the coverage enhancement information indicates at least one of: a transport block (TB) scaling parameter, a frequency hopping parameter, a repetition parameter, or a TB over multiple slots parameter.

Aspect 41: The method of any of Aspects 31-40, wherein transmitting the first message comprises: transmitting the first message in at least one of: a downlink time interval, a flexible time interval, a full-duplex time interval, a subband-full-duplex time interval, a frequency-division-duplexing time interval, or a time-division-duplexing time interval.

Aspect 42: The method of any of Aspects 31-41, further comprising: transmitting a configuration of a search space, and wherein transmitting the first message comprises: transmitting the first message via the search space. wherein transmitting the first message comprises: transmitting the first message via the search space.

Aspect 43: The method of Aspect 42, wherein the search space is a common search space or a user equipment (UE) specific search space.

Aspect 44: The method of any of Aspects 31-43, wherein the first message is associated with one or more fixed parameters.

Aspect 45: The method of Aspect 44, wherein the one or more fixed parameters include at least one of: a modulation order, a size, a coding rate, or an aggregation level.

Aspect 46: The method of any of Aspects 31-45, further comprising: transmitting information indicative of a respective range of values for each parameter of one or more parameters associated with the multi-stage grant.

Aspect 47: The method of Aspect 46, wherein the one or more parameters include at least one of: a size, a coding rate, or an aggregation level.

Aspect 48: The method of any of Aspects 31-47, wherein the first message is scrambled via a radio network temporary identifier (RNTI).

Aspect 49: The method of Aspect 48, wherein the RNTI is a user equipment (UE) specific RNTI, a group RNTI, or a fixed RNTI.

Aspect 50: The method of any of Aspects 31-49, wherein transmitting the first message comprises: transmitting the first message via at least one transmission associated with the first RAT, wherein the at least one transmission includes: a synchronization signal block (SSB) transmission, a physical downlink control channel (PDCCH) transmission, or a physical downlink shared channel (PDSCH) transmission.

Aspect 51: The method of Aspect 50, wherein the first message is multiplexed in the at least one transmission.

Aspect 52: The method of any of Aspects 31-51, wherein transmitting the first message comprises: transmitting multiplexed information, wherein the multiplex information includes the first message.

Aspect 53: The method of Aspect 52, wherein the multiplexed information includes: a synchronization signal block (SSB) transmission, a physical downlink control channel (PDCCH) transmission, or a physical downlink shared channel (PDSCH) transmission.

Aspect 54: The method of any of Aspects 31-53, wherein the first message and the second message are associated with a same channel coding scheme.

Aspect 55: The method of any of Aspects 31-54, wherein the first message is associated with a first channel coding scheme and the second message is associated with a second channel coding scheme.

Aspect 56: The method of any of Aspects 31-55, wherein the second frequency carrier is associated with a first frequency range that is equal to or greater than a second frequency range associated with the first frequency carrier.

Aspect 57: The method of any of Aspects 31-56, wherein communicating the communication comprises: transmitting, via a downlink data channel, the communication.

Aspect 58: The method of any of Aspects 31-57, wherein communicating the communication comprises: receiving, via an uplink data channel, the communication.

Aspect 59: The method of any of Aspects 31-58, wherein transmitting the second message comprises: transmitting the second message after transmitting the first message.

Aspect 60: An apparatus for wireless communication at a device, comprising one or more processors; memory coupled with the processor; and instructions stored in the memory and executable by the one or more processors to cause the apparatus to perform the method of one or more of Aspects 1-30 and/or 31-59.

Aspect 61: A device for wireless communication, comprising one or more memories and one or more processors coupled to the one or more memories, the one or more processors configured to perform the method of one or more of Aspects 1-30 and/or 31-59.

Aspect 62: An apparatus for wireless communication, comprising at least one means for performing the method of one or more of Aspects 1-30 and/or 31-59.

Aspect 63: A non-transitory computer-readable medium storing code for wireless communication, the code comprising instructions executable by one or more processors to perform the method of one or more of Aspects 1-30 and/or 31-59.

Aspect 64: A non-transitory computer-readable medium storing a set of instructions for wireless communication, the set of instructions comprising one or more instructions that, when executed by one or more processors of a device, cause the device to perform the method of one or more of Aspects 1-30 and/or 31-59.

Aspect 65: A device for wireless communication, comprising at least one memory, at least one communication interface and one or more processors coupled to the at least one memory and the at least one communication interface, the device configured to perform the method of one or more of Aspects 1-30 and/or 31-59.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. Systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, because those skilled in the art understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing and other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein is critical or essential unless explicitly described as such. Also, as used herein, the articles “a” and “an” include one or more items and may be used interchangeably with “one or more.” Further, as used herein, the article “the” includes one or more items referenced in connection with the article “the” and may be used interchangeably with “the one or more.” Furthermore, as used herein, the terms “set” and “group” include one or more items and may be used interchangeably with “one or more.” Where only one item is intended, the phrase “only one” or similar language is used. Also, as used herein, the terms “has,” “have,” “having,” or the like are open-ended terms that do not limit an element that they modify (e.g., an element “having” A may also have B). Further, as used herein, “based on” is in the inclusive sense, unless otherwise explicitly indicated. For example, “based on” may be used interchangeably with “based at least in part on,” “associated with”, or “in accordance with” unless otherwise explicitly indicated. The phrase “based on” shall not be construed as a reference to a closed set of information, one or more conditions, one or more factors, or the like. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is inclusive when used in a series and may be used interchangeably with “and/or,” unless explicitly stated otherwise (e.g., if used in combination with “either” or “only one of”).

What is claimed is:

1. A network entity for wireless communication, comprising:
at least one memory;
at least one communication interface; and
at least one processor coupled to the at least one memory and the at least one communication interface, wherein the network entity is configured to:
receive, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first radio access technology (RAT);
receive, via a second frequency carrier, the second message of the multi-stage grant, wherein the second message indicates second information associated with the communication, and wherein the second frequency carrier is associated with a second RAT; and
communicate, based on the second information, the communication.

2. The network entity of claim 1, wherein the first frequency carrier is associated with the second RAT.

3. The network entity of claim 1, wherein a multi-RAT shared spectrum includes the first frequency carrier.

4. The network entity of claim 1, wherein the first information indicates a first resource allocation for the second message, and
wherein the second information indicates a second resource allocation for the communication.

5. The network entity of claim 4, wherein, to receive the second message, the network entity is configured to receive, via the first resource allocation, the second message, and
wherein, to communicate the communication, the network entity is configured to communicate, via the second resource allocation, the communication.

6. The network entity of claim 1, wherein the first information indicates a first one or more communication parameters associated with the second message, and
wherein the second information indicates a second one or more communication parameters associated with the communication.

7. The network entity of claim 6, wherein, to receive the second message, the network entity is configured to receive the second message based on the first one or more communication parameters, and
wherein, to communicate the communication, the network entity is configured to communicate the communication based on the second one or more communication parameters.

8. The network entity of claim 1, wherein the first information indicates at least one of:
a format associated with the multi-stage grant,
the second frequency carrier,
a priority level of the second message,
a monitoring adaptation parameter,
a radio resource allocation of the second message,
a size of the second message,
a code rate of the second message,
a demodulation reference signal configuration of the second message, or
a cyclic redundancy check configuration of the second message.

9. The network entity of claim 1, wherein the second information indicates, for the communication, at least one of:
a third frequency carrier,
a bandwidth part,
a scheduling offset parameter,
a radio resource allocation,
coverage enhancement information,
precoding information,
antenna port information,
a modulation and coding scheme,
a new data indicator,
hybrid automatic repeat request (HARQ) information,
power control information, or
reference signal resource information.

10. The network entity of claim 9, wherein the coverage enhancement information indicates at least one of:
a transport block (TB) scaling parameter,
a frequency hopping parameter,
a repetition parameter, or
a TB over multiple slots parameter.

11. The network entity of claim 1, wherein the network entity is configured to:
decode the first message via a blind decoding operation; and
decode the second message based on the first information.

12. The network entity of claim 1, wherein, to receive the first message, the network entity is configured to:
receive the first message in at least one of:
a downlink time interval,
a flexible time interval,
a full-duplex time interval,
a subband-full-duplex time interval,
a frequency-division-duplexing time interval, or
a time-division-duplexing time interval.

13. The network entity of claim 1, wherein the network entity is configured to:
receive a configuration of a search space, and
wherein, to receive the first message, the network entity is configured to:
receive the first message via the search space.

14. The network entity of claim 13, wherein the search space is a common search space or a user equipment (UE) specific search space.

15. The network entity of claim 1, wherein the first message is associated with one or more fixed parameters.

16. The network entity of claim 15, wherein the one or more fixed parameters include at least one of:
a modulation order,
a size,
a coding rate, or
an aggregation level.

17. A first network entity for wireless communication, comprising:
at least one memory;
at least one communication interface; and
at least one processors coupled to at least one memory and the at least one communication interface, wherein the first network entity is configured to:
transmit, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first radio access technology (RAT);
transmit, via a second frequency carrier, the second message of the multi-stage grant, wherein the second message indicates second information associated with the communication, and wherein the second frequency carrier is associated with a second RAT; and
communicate, based on at least one of the first information or the second information, the communication.

18. The first network entity of claim 17, wherein a multi-RAT shared spectrum includes the first frequency carrier.

19. The first network entity of claim 17, wherein the first information indicates a first resource allocation for the second message, and
wherein the second information indicates a second resource allocation for the communication.

20. The first network entity of claim 19, wherein, to transmit the second message, the first network entity is configured to transmit, via the first resource allocation, the second message, and
wherein, to communicate the communication, the first network entity is configured to communicate, via the second resource allocation, the communication.

21. The first network entity of claim 17, wherein the first information indicates a first one or more communication parameters associated with the second message, and
wherein the second information indicates a second one or more communication parameters associated with the communication.

22. The first network entity of claim 21, wherein, to transmit the second message, the network entity is configured to transmit the second message based on the first one or more communication parameters, and
wherein, to communicate the communication, the first network entity is configured to communicate the communication based on the second one or more communication parameters.

23. The first network entity of claim 17, wherein the first information indicates at least one of:
a format associated with the multi-stage grant,
the second frequency carrier,
a priority level of the second message,
a monitoring adaptation parameter,
a radio resource allocation of the second message,
a size of the second message,
a code rate of the second message,
a demodulation reference signal configuration of the second message, or
a cyclic redundancy check configuration of the second message.

24. The first network entity of claim 17, wherein the second information indicates, for the communication, at least one of:
a third frequency carrier,
a bandwidth part,
a scheduling offset parameter,
a radio resource allocation,
coverage enhancement information,
precoding information,
antenna port information,
a modulation and coding scheme,
a new data indicator,
hybrid automatic repeat request (HARQ) information,
power control information, or
reference signal resource information.

25. A method of wireless communication performed by a network entity, comprising:
receiving, via a first frequency carrier, a first message of a multi-stage grant that includes the first message and a second message, wherein the multi-stage grant schedules a communication, wherein the first message indicates first information associated with the second message of the multi-stage grant, and wherein the first frequency carrier is associated with a first radio access technology (RAT);
receiving, via a second frequency carrier, the second message of the multi-stage grant, wherein the second message indicates second information associated with the communication, and wherein the second frequency carrier is associated with a second RAT; and
communicating, based on the second information, the communication.

26. The method of claim 25, further comprising:
receiving information indicative of a respective range of values for each parameter of one or more parameters associated with the multi-stage grant,
wherein the one or more parameters are associated with the first message.

27. The method of claim 26, wherein the one or more parameters include at least one of:
a size,
a coding rate, or
an aggregation level.

28. The method of claim 25, wherein the first message is scrambled via a radio network temporary identifier (RNTI).

29. The method of claim 28, wherein the RNTI is a user equipment (UE) specific RNTI, a group RNTI, or a fixed RNTI.

30. The method of claim 25, wherein receiving the first message comprises:
receiving the first message via at least one transmission associated with the first RAT, wherein the at least one transmission includes:
a synchronization signal block (SSB) transmission,
a physical downlink control channel (PDCCH) transmission, or
a physical downlink shared channel (PDSCH) transmission.

31. The method of claim 30, wherein the first message is multiplexed in the at least one transmission.

32. The method of claim 25, wherein receiving the first message comprises:
receiving multiplexed information, wherein the multiplexed information includes the first message.

33. The method of claim 32, wherein the multiplexed information includes:
a synchronization signal block (SSB) transmission,
a physical downlink control channel (PDCCH) transmission, or
a physical downlink shared channel (PDSCH) transmission.

34. The method of claim 25, wherein the first message and the second message are associated with a same channel coding scheme.

35. The method of claim 25, wherein the first message is associated with a first channel coding scheme and the second message is associated with a second channel coding scheme.

36. The method of claim 25, wherein the second frequency carrier is associated with a first frequency range that is equal to or greater than a second frequency range associated with the first frequency carrier.

37. The method of claim 25, wherein communicating the communication comprises:
transmitting, via an uplink data channel, the communication.

38. The method of claim 25, wherein communicating the communication comprises:
receiving, via a downlink data channel, the communication.

39. The method of claim 25, wherein receiving the second message comprises:
receiving the second message after receiving the first message.

40. A method of wireless communication performed by a first network entity, comprising:
transmitting, via a first frequency carrier, a first message of a multi-stage grant that includes the first message and a second message, wherein the multi-stage grant schedules a communication for a second network entity, wherein the first message indicates first information associated with a second message of the multi-stage grant, and wherein the first frequency carrier is associated with a first radio access technology (RAT);
transmitting, via a second frequency carrier, the second message of the multi-stage grant, wherein the second message indicates second information associated with the communication, and wherein the second frequency carrier is associated with a second RAT; and
communicating, based on at least one of the first information or the second information, the communication.

41. The method of claim 40, further comprising:
transmitting a configuration of a search space, and
wherein transmitting the first message comprises:
transmitting the first message via the search space.

42. The method of claim 40, wherein the first message is associated with one or more fixed parameters.

43. The method of claim 40, further comprising:
transmitting information indicative of a respective range of values for each parameter of one or more parameters associated with the multi-stage grant.

44. The method of claim 40, wherein transmitting the first message comprises:
transmitting the first message via at least one transmission associated with the first RAT, wherein the at least one transmission includes:
a synchronization signal block (SSB) transmission,
a physical downlink control channel (PDCCH) transmission, or
a physical downlink shared channel (PDSCH) transmission.

45. The method of claim 40, wherein transmitting the first message comprises:
transmitting multiplexed information, wherein the multiplex information includes the first message.
